(19) United States
(12) Patent Application Publication
(10) Pub. No.: US 2009/0151531 A1
(43) Pub. Date: Jun. 18, 2009

(54) PROCESS FOR CRAFTING PAPER AND RELATED KIT

(75) Inventors: Susan W. Levin, Port Hueneme, CA (US); Patricia Ann Donham, Santa Paula, CA (US)

Correspondence Address: KELLY LOWRY & KELLEY, LLP, 6320 CANOGA AVENUE, SUITE 1650, WOODLAND HILLS, CA, 91367, US

(73) Assignee: K1C2, LLC, Ventura, CA (US)

(21) Appl. No.: 11/957,699

(22) Filed: Dec. 17, 2007

(51) Int. Cl. B26D 7/27; B31B 49/00

(52) U.S. Cl. 83/565; 493/37

(57) ABSTRACT

The process for crafting paper includes providing a double-sided mat having a cutting surface on one side and a scoring surface on an opposite side. Both the cutting surface and the scoring surface each have measurement indicia thereon. Paper is scored or cut on respective sides of the mat with a ruler having a channel formed therein. The channel is capable of receiving a scoring knob or a cutting blade for precisely cutting or scoring arches, circles or straight lines. The mat and ruler are also configured to construct box tops that precisely fit relatively smaller box bottoms.

### BACKGROUND OF THE INVENTION

The present invention generally relates to a process for crafting paper and a related kit. More particularly, the present invention relates to a process and kit for scoring and cutting crafting paper into a variety of three-dimensional structures using a double-sided mat, multiple rulers, and a cutting or scoring tool.

Tools and kits for making a variety of crafts having unique designs, such as boxes, paper sculptures, toys and art work, are generally known in the art. In particular, boxes or containers having straight or curved designs can be difficult to repeat, especially for the do-it-yourself hobbiest, artist, or other person desiring to create boxes from cardstock, cardboard, plastic or other similar sheet stock material. Often, it is difficult to accurately align the cardstock to consistently repeat the cuts and scorelines necessary to create curved or straight edge crafts and boxes.

There are kits known in the art that are designed to make boxes and crafts in a variety of shapes, sizes and volumes. These kits usually construct, for example, the boxes or cartons from several semi-rigid pieces of cardboard or cardstock. Some kits require the use of two different sizes of cardstock to properly form a box top that fits over and engages the corresponding box bottom. The cardstock of the box top would need to be longer and wider than the cardstock used to create the box bottom. Other kits provide a cutting means for cutting larger cardstock to the desired dimensions for making such a box. In these kits, only one cardstock size is required to make the box or other craft.

The process for making a box, in the example above, starts by obtaining pre-sized cardstock or otherwise cutting the cardstock to the desired dimensions of a pre-folded box top and a pre-folded box bottom. The pre-folded box top and bottom includes additional material necessary to fold the requisite walls and flaps of the box together. The cardstock is scored where fold lines are needed to create the sidewalls of the box top and box bottom. The cardstock is then folded along these scorelines to form the sidewalls. Thereafter, a set of flaps are notched into these sidewalls. The notches allow the corners of the sidewalls of the respective box top and box bottom to fold into one another. The resulting flaps may be pre-cut into the cardstock or otherwise cut by hand. There are currently no tools known in the art that cut uniform notches. Kits for making such a box may include a scoring and slotting machine adaptable for producing boxes in a variety of sizes. These machines are often expensive and usually are not suitable for individual or home use.

Other less expensive kits are available to individuals for making custom boxes. These kits provide instructions for making boxes from cardstock having a variety of shapes and sizes. In particular, these include devices for forming straight and curved scoring and cutting lines. U.S. Pat. Nos. 5,707,327 and 5,484,373 to Carbone disclose devices that have a scoring plate with a plurality of grooves formed therein. The cardstock is placed over the grooves and a scoring tool is used to form scorelines therein. The distance between the scorelines is limited to the width between the grooves (e.g. one-half inch). Furthermore, U.S. Pat. No. 6,216,354 also to Carbone discloses a similar method of making curved scorelines from cardstock. While these methods help perfect straight and curved scorelines, the devices make it difficult to otherwise use the base for other activities because of the indentations in the device itself. These cardstock blanks may be similarly scored and folded into box tops and box bottoms for matingly fitting together over one another. Unlike a scoring and slotting machine, such a kit does not require additional tools or a power source to make the boxes.

Accordingly, there is a need for an inexpensive and easy to use home kit and process for making boxes and other crafts having a variety of shapes and designs. Such a kit should be adapted for use with a variety of different cardstock sizes, should be capable of producing straight and curved cuts and scorelines, should provide a dual-sided mat having surfaces specifically designed for cutting and scoring, should include rulers for making precision straight and curved scorelines and cuts and should include a tool for forming foldable flaps ideal for forming box corners. The present invention fulfills these needs and provides further related advantages.

### SUMMARY OF THE INVENTION

The process for crafting paper in accordance with the present invention includes providing a double-sided mat having a cutting surface on one side and a scoring surface on an opposite side. Both the cutting surface and the scoring surface each have measurement indicia thereon. In one embodiment, paper is first placed on the cutting surface of the mat. Then, a ruler having a channel is disposed over the paper. Accordingly, a cutting blade is positioned within the channel and extends through the width of the ruler to contact the paper. Thereafter, the paper is cut with the cutting blade within the track formed by the channel. In a preferred embodiment, the ruler is formed such that an arch, a circle or a straight line may be cut into the paper. Accordingly, a three-dimensional structure may be formed by folding the paper between a set of cut arches. To ensure precise cutting, the paper is aligned with the measurement indicia on the cutting surface.

Additionally, the double-sided mat may be flipped over such that the paper may be set on the scoring surface of the mat. The ruler is then put over the paper such that a scoring knob may be located within a channel formed in the ruler to contact the paper. Similar to cutting, the paper is then scored with the scoring knob. In a preferred embodiment, the channel is capable of scoring an arch, a circle or a straight line wherein folding the paper about a scoreline forms a three-dimensional structure. Furthermore, the measurement indicia on the scoring surface includes a first line for scoring a box bottom base and a second line offset from the first line for scoring a box top base relatively greater in width and height than the box bottom base. A set of sidewalls may be notched by a cornering device having a pair of angled cutting channels such that the foldable flaps may be adhered to each respective sidewall.

The present invention may also include a universal tool wherein the cutting blade and the scoring knob may be interchanged. The cutting blade or scoring knob may thereafter be stored in a compartment in the tool. Alternatively, the paper may be torn along a straight or curved deckled edge of the ruler. A lip of the ruler may also catch an edge of the mat to ensure accurate and precise cutting or scoring of the paper.

In an alternative embodiment of the present invention, the process for crafting paper includes providing a double-sided mat having a cutting surface on one side and a scoring surface on the opposite side. Both the cutting surface and the scoring surface each include measurement indicia thereon. In this embodiment, the paper is first placed on the scoring surface of the mat. Next, a ruler having a channel is disposed over the paper. Accordingly, a scoring knob is positioned within the channel to contact the paper below. Thereafter, the paper may be scored with the scoring knob within the track formed by the channel. Preferably, the ruler is formed such that an arch, a circle or a straight line may be scored into the paper. Alternatively, the scoring knob can be used to emboss the paper. Folding the paper about a scoreline forms a three-dimensional structure. To ensure accurate and precise scoring, the paper is aligned with the measurement indicia on the scoring surface.

The process for crafting paper may also include forming circular cuts or scorelines. First, a pin is inserted through an aperture in a center of the mat such that when placing the paper on the scoring surface, the pin pokes a hole through the paper. Thereafter, the pin is positioned through an aperture in a curved ruler when disposing a ruler over the paper. Rotating the curved ruler about the pin enables scoring of an arch or a circle therein.

In an alternative embodiment of the process for crafting paper of the present invention, the paper is set on the cutting surface of the mat after flipping over the double-sided mat. Thereafter, the ruler is put over the paper such that locating a cutting blade in the channel of the ruler contacts the paper disposed below. The cutting blade is then able to cut an arch, a circle or a straight line into the paper. The cutting step may also include notching a foldable flap from a box sidewall. The notch should be capable of being adhered to the sidewall to form a three-dimensional structure. Like the steps for scoring described above, a pin may be inserted through an aperture in the center of the mat such that a hole is poked in the paper with the pin when setting the paper on the cutting surface. The pin is then positioned through an aperture in a curved ruler when putting the ruler over the paper. Rotating the curved ruler about the pin enables cutting of an arc or circle in the paper.

Alternatively, the present invention provides a paper crafting kit having a double-sided mat with a cutting surface on one side and a scoring surface on an opposite side, wherein each side includes measurement indicia. Specifically, the scoring side further includes a first line for scoring a box bottom base and a second line offset from the first line for scoring a box top base relatively larger in height and width than the box bottom base. Preferably, the second line is offset from the first line by one-eighth inch. The kit also includes a ruler engageable with the mat. The ruler has a channel such that the cutting blade or the scoring knob is selectively insertable therein for cutting or scoring, respectively. The ruler and corresponding channel may be aligned with any of the measurement indicia to ensure accurate cutting or scoring. The measurement indicia includes a horizontal line, a vertical line, a circle or a diagonal line. Furthermore, the ruler may be a curved ruler having a first alignment aperture for scoring a round box top and a second alignment aperture offset from the first alignment aperture for scoring a round box bottom relatively larger in diameter than the round box top. Accordingly, the cutting surface is preferably formed from a hard plastic material while the scoring surface is made from a soft foam-like material. Any type of paper may be used with the invention, including vellum, construction paper, cardboard or cardstock.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a paper crafting kit in accordance with the present invention;

FIG. 2 is a top view of a dual-sided mat, illustrating the cutting side;

FIG. 3 is a bottom view of the mat of FIG. 2, illustrating the scoring side;

FIG. 4 is a top view of a straight ruler for use with the present invention;

FIG. 5 is a cross-sectional view of the straight ruler of FIG. 4, taken about the line 5-5;

FIG. 6 is a top view of a curved ruler having multiple cutting arcs and deckled edges;

FIG. 7 is a cross-sectional view of the curved ruler of FIG. 6, taken about the line 7-7;

FIG. 8 is a top view of a cornering tool in accordance with the present invention;

FIG. 9 is a bottom view of the cornering tool of FIG. 8;

FIG. 10 is a perspective view of a scoring tool in accordance with the present invention;

FIG. 11 is an exploded perspective view of the scoring tool of FIG. 10;

FIG. 12 is a perspective view of a cutting tool in accordance with the present invention, illustrating removal of a protective cap;

FIG. 13 is an exploded perspective view of the cutting tool of FIG. 12;

FIG. 14 is a perspective view of a pin and a cap;

FIG. 15 is an exploded perspective view of the pin and the cap of FIG. 14;

FIG. 16 is a perspective view illustrating alignment of the straight ruler with the dual-sided mat and the cutting tool;

FIG. 17 is a side view of the scoring tool disposed within a channel in the ruler;

FIG. 18 is a side view of the cutting tool disposed within a channel in the ruler;

FIG. 19 is a perspective view illustrating alignment of the paper, dual-sided mat, ruler and the cutting tool;

FIG. 20 is a side view illustrating movement of the cutting tool within the channel of the ruler;

FIG. 21 is a top view of a process for dimensioning paper by cutting a left side of the paper on a cutting side of the double-sided mat;

FIG. 22 is an another top view of FIG. 21, illustrating cutting a right side of the paper;

FIG. 23 is an another top view FIG. 21, illustrating cutting a bottom portion of the paper;

FIG. 24 is an another top view of FIG. 21, illustrating cutting a top portion of the paper;

FIG. 25 is a top view illustrating scoring the left side of a box bottom dimensioned in FIGS. 21-24;

FIG. 26 is a top view illustrating scoring a right side of the box bottom of FIG. 25;

FIG. 27 is a top view illustrating the box bottom of FIGS. 25-26 having four scored sidewalls;

FIG. 28 is a perspective view of the paper crafting process, illustrating cutting a foldable flap on a right side of the box with a cornering tool;

FIG. 29 is another perspective view of FIG. 28, illustrating cutting foldable flaps on a left side of the box;

FIG. 30 is a top view illustrating placement of the cornering tool along the four corners of the box bottom;

FIG. 31 is a top view of the box bottom having scorelined sidewalls and foldable flaps;

FIG. 32 is a top view illustrating scoring the left side of a box top, offset on the mat by one-eighth inch;

FIG. 33 is another top view of FIG. 32, illustrating scoring a right side of the box top;

FIG. 34 is a top view illustrating the box top of FIGS. 32-33 having four scored sidewalls;

FIG. 35 is a top view illustrating aligning the cornering tool to cut a foldable flap;

FIG. 36 is a top view of the box top having foldable sidewalls and foldable flaps;

FIG. 37 is a perspective view illustrating forming a three-dimensional box top or box bottom;

FIG. 38 is an exploded perspective view of a box having engaging top and bottom sections;

FIG. 39 is a perspective view of the box of FIG. 38, illustrating engagement of the box top to the box bottom;

FIG. 40 is a top view of a box top on the mat;

FIG. 41 is a top view of a box bottom relatively larger than the box top of FIG. 40;

FIG. 42 is an exploded perspective view illustrating engagement of the box top of FIG. 40 with the relatively larger box bottom of FIG. 41;

FIG. 43 is a perspective view illustrating engagement of the box top and the box bottom of FIG. 42;

FIG. 44 is a top view illustrating scoring paper for forming a pillow box;

FIG. 45 is a top view of the paper of FIG. 44, having a pair of scorelines formed therein;

FIG. 46 is an exploded perspective view illustrating alignment of a curved ruler with the double-sided mat, the pin and the cap, and the cutting blade;

FIG. 47 is a perspective view illustrating cutting a window with the curved ruler and the cutting tool;

FIG. 48 is a top view of the cutting process of FIG. 47;

FIG. 49 is a top view of a pre-folded pillow box having the window formed therein;

FIG. 50 is a perspective view, illustrating folding the pre-folded pillow box of FIG. 49 along the scorelines;

FIG. 51 is a top view illustrating cutting curved ends of the pillow box with a curved ruler via alignment with the pin and cap;

FIG. 52 is a top view illustrating cutting curved ends of the pillow box by free hand;

FIG. 53 is a top view of a pillow box having cut curved ends;

FIG. 54 is a top view illustrating trimming a sidewall;

FIG. 55 is a top view illustrating scoring the curved ends of the pillow box with a curved ruler via alignment with the pin and cap;

FIG. 56 is a top view illustrating scoring the curved ends of the pillow box by free hand;

FIG. 57 is a top view of the pre-folded pillow box having the window and a set of foldable ends;

FIG. 58 is a top view illustrating folding the curved ends of the pillow box about the scorelines;

FIG. 59 is a perspective view of the pillow box of FIG. 58, illustrating forming the box;

FIG. 60 is a perspective view of a three-dimensional pillow box;

FIG. 61 is a perspective view illustrating scoring a circle of a round box bottom;

FIG. 62 is a perspective view illustrating cutting a larger diameter circle relative to the circular scoreline of the round box bottom of FIG. 61;

FIG. 63 is a perspective view illustrating forming foldable flaps with the cutting device;

FIG. 64 illustrates bending the foldable flaps about the circular scoreline;

FIG. 65 is a perspective view of the round box bottom of FIG. 64, illustrating all the foldable flaps folded about the circular scoreline;

FIG. 66 is a perspective view of the round box bottom of FIG. 65, illustrating a sidewall adhered to the folded flaps;

FIG. 67 is a perspective view illustrating scoring a round box top using an offset aperture in the curved ruler;

FIG. 68 is a perspective view illustrating cutting a round box top using the offset aperture in the curved ruler;

FIG. 69 is a perspective view illustrating the round box top having all the flaps folded about the circular scoreline;

FIG. 70 is a perspective view of the round box top of FIG. 69, illustrating a sidewall adhered to the folded flaps;

FIG. 71 is an exploded perspective view of the round box having engaging top and bottom sections;

FIG. 72 is a perspective view of the round box of FIG. 71, illustrating engagement of the round box top to the round box bottom;

FIG. 73 is a perspective view illustrating creating a curved deckle in the paper;

FIG. 74 is a perspective view illustrating creating a straight deckle in the paper;

FIG. 75 is a top view of a card having scorelines and cuts formed therein;

FIG. 76 is a perspective view of the card of FIG. 75 in three-dimensional form and offset from a backing;

FIG. 77 is a perspective view of the three-dimensional card of FIG. 76, illustrating engagement with multiple pages; and

FIG. 78 is a perspective view of the multiple pages of FIG. 77 collapsed together.

### DETAILED DESCRIPTION OF THE PREFERRED EMBODIMENTS

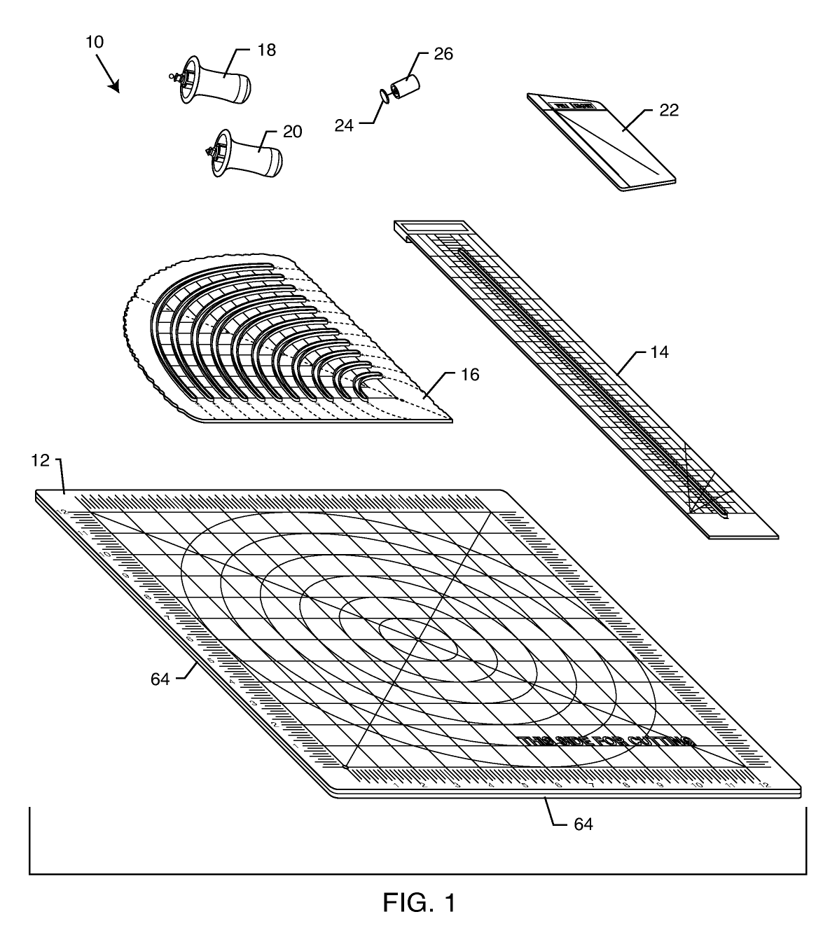

As shown in the exemplary drawings for purposes of illustration, the present invention for a process for crafting paper and the related kit is generally referred to by the reference numeral 10. Turning to the representative figures in the specification, FIG. 1 illustrates the paper crafting kit 10 including a double-sided mat 12, a straight ruler 14, a curved ruler 16, a scoring tool 18, a cutting tool 20, a cornering tool 22, and a pin 24 with a corresponding cap 26. The paper crafting kit 10 of the present invention is ideal for scrap booking, paper crafts, card making, embossing, deckling, pop-ups, envelopes, boxes (circular or rectangular) with interlocking tops or a variety of other crafts known in the art. Each of the above-identified components of the paper crafting kit 10 are preferably marketed together so any of the preceding crafts may be made with one kit. Although, one or more components may be sold separately. Such a kit may also include an instruction booklet and an accompanying instructional DVD that provides step-by-step instructions for creating hundreds of project ideas embodying the above-identified general crafts. Moreover, the paper crafting kit 10 of the present invention is ideal for the creation of a variety of projects that may require gluing light-weight papers to cardstock or chipboard before cutting or scoring final designs.

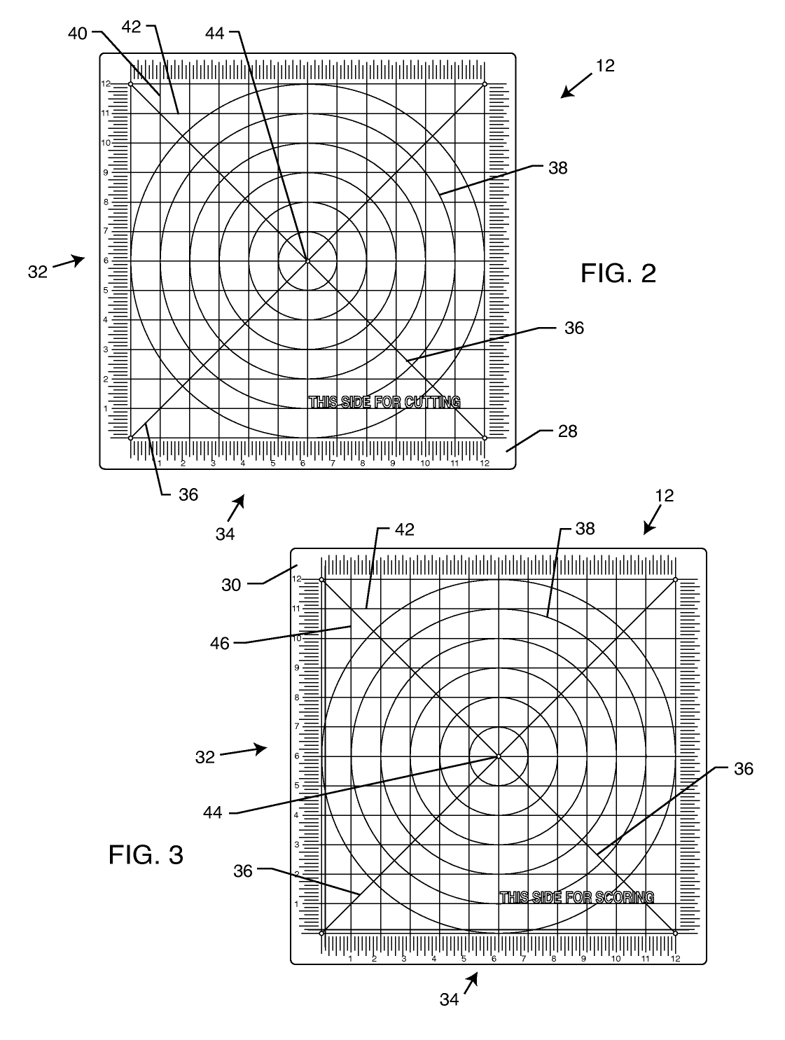

The double-sided mat 12 is preferably 13 inches by 13 inches and includes a cutting side 28 (FIG. 2) and a scoring side 30 (FIG. 3). Both the cutting side 28 and the scoring side 30 include a plurality of measurement indicia that include a set of vertical markings 32, a set of horizontal markings 34, a pair of diagonal markings 36 and a set of circular markings 38. As shown in FIGS. 2 and 3, a set of major vertical markings 40 and a set of major horizontal markings 42 preferably extend the height or width of the double-sided mat 12 and are spaced apart by one-inch. Moreover, the circular markings 38 are similarly preferably increased by a radius of one-inch (or a diameter of two inches) with each progressive marking. Each of the diagonal markings 36 intersect at the middle of the double-sided mat 12 at an aperture 44. The aperture 44 is used in conjunction with the curved ruler 16 and the pin 24 and the corresponding cap 26, discussed in more detail herein. The cutting side 28 is preferably made from a resilient plastic-like material capable of withstanding a cutting blade. The scoring side 30 is preferably made from an indentable foam-like material capable of indenting when a scoring knob is depressed therein.

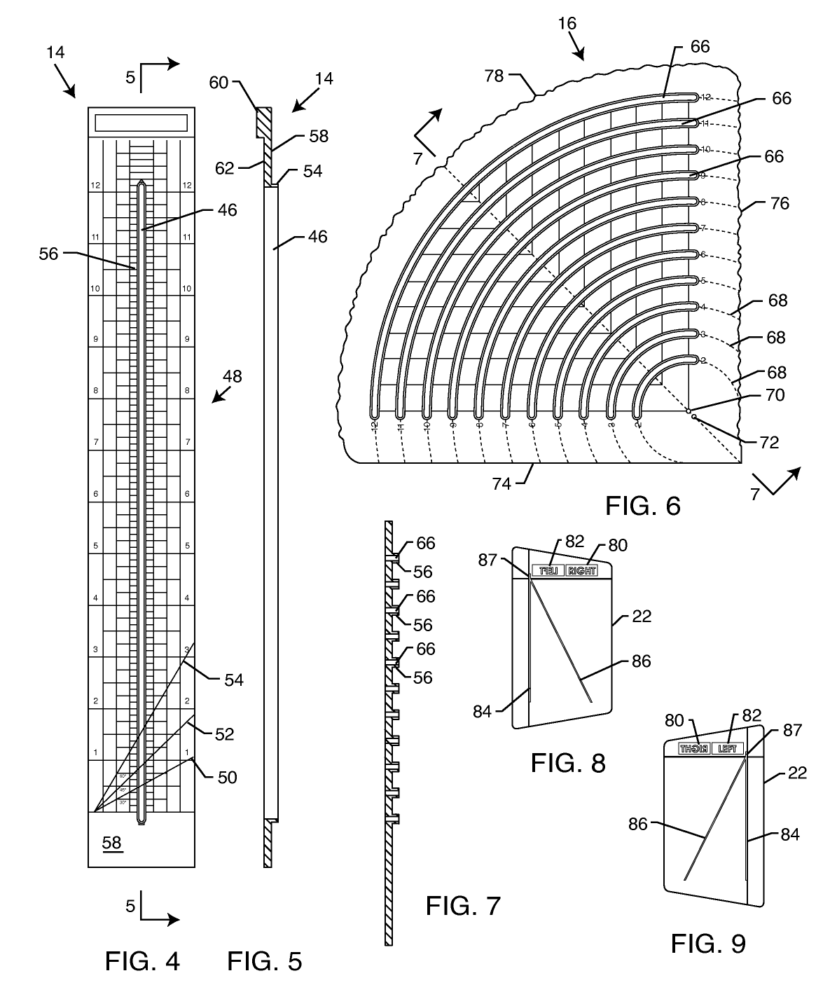

The straight ruler 14 is shown in FIG. 4 and includes a straight channel 46 and a set of measurements 48 running along the longitudinal length thereof. The measurements 48 may be used in conjunction with any of the markings 32, 34, 36, 38 of the double-sided mat 12 when scoring or cutting paper as described herein. The measurements 48 are preferably marked every inch with one-eighth inch submarkings therebetween. The straight ruler 14 also includes a thirty degree marking 50, a forty-five degree marking 52 and a sixty degree marking 54. The degree markings 50, 52, 54 provide accurate angled measurements when cutting or scoring paper at angles offset to a straight plane. The degree markings 50, 52, 54 and the measurements 48 enable precise cutting and scoring during paper crafting.

The straight ruler 14 further includes the straight channel 46 shown in FIG. 4 and in the cross-sectional view in FIG. 5. The straight channel 46 includes a flange 56 extending around the exterior perimeter of the straight channel 46. The flange 56 extends beyond a top surface 58 plane of the straight ruler 14 to engage the scoring tool 18 or the cutting tool 20 to provide maximum stability when cutting or scoring, respectively. The raised flange 56 also prevents side-to-side movement of the scoring tool 18 or the cutting tool 20 within the channel 46. Accordingly, the straight channel 46 and the extended flange 56 provide maximum engagement of the scoring tool 18 or the cutting tool 20 during scoring or cutting, respectively. Cutting or scoring with the straight channel 46 is particularly advantageous over standard rulers. For example, scoring with a standard ruler would cause the scoring tool 18 to be slightly offset when run down the side of a standard ruler. To compensate for the offset, the standard ruler would need to be shifted from the desired mark to create a proper scoreline. The channel 46 aligns precisely with the desired mark and no shift is necessary. Moreover, a lip 60 extending below a bottom surface 62 of the straight ruler 14 is used to engage any one of the four side edges 64 (FIG. 1) of the double-sided mat 12. The lip 64 catches the side edge 64 to ensure proper alignment with any of the markings 32, 34, 36, 38 for precise scoring or cutting. The lip 60 may slide longitudinally along the side edge 64 for easily repositioning the straight ruler 14 along any of the markings 32, 34, 36, 38 on the double-sided mat 12.

The curved ruler 16 is generally shown in FIG. 6 and includes a plurality of curved channels 66 similar to the straight channel 46 of the straight ruler 14. The curved channels 66 are preferably spaced apart by one-inch as shown by a set of numbered curved markings 68. Accordingly, the numbers residing next to the set of curved markings 68 represent the radius of the resulting circle, in inches. Of course, other measurement standards such as metric units may be used with any of the markings 32, 34, 36, 38, 40, 42, 68. Thus, in a preferred embodiment, the smallest circle has a two-inch radius and the largest circle has a twelve-inch radius. The plurality of curved channels 66 are shown in a side view in FIG. 7 and also have the corresponding flanges 56 previously described with the straight channel 46. The curved channels 66 perform a similar function in aligning either the scoring tool 18 or the cutting tool 20 therein during cutting or scoring arcs or circles as the straight channel 46. The curved channels 66 ensure accurate and precise circle or arch formation.

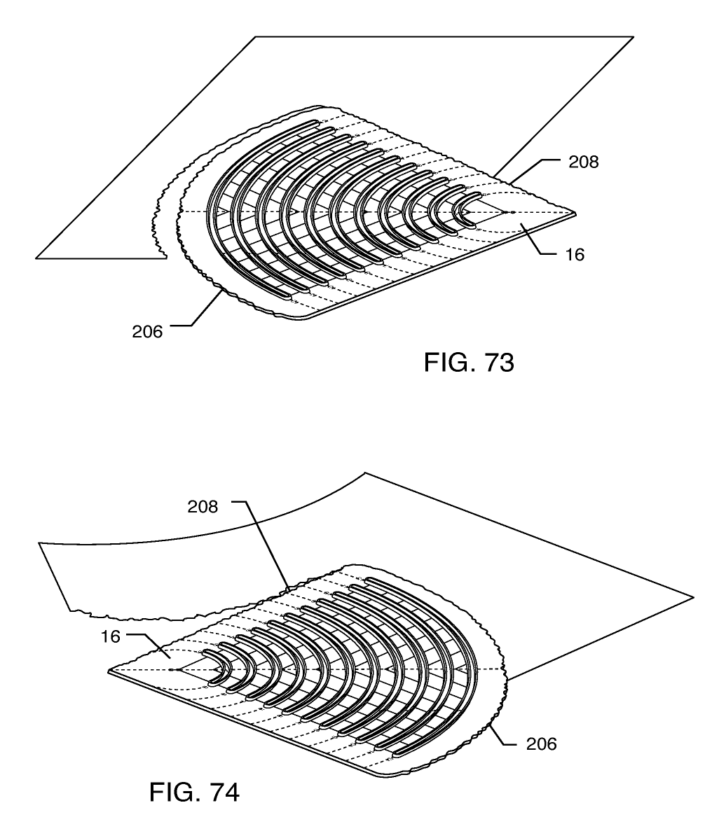

The curved ruler 16 further includes a lower aperture 70 and an upper aperture 72. As will be described in more detail herein, the lower aperture 70 is used to make a box bottom relatively smaller in diameter than a corresponding box top formed by using the upper aperture 72. The curved ruler 16 also includes a straight edge 74 for measuring straight lines similar to those that might be measured with the straight ruler 14. Lastly, the curved ruler 16 includes a deckled straight edge 76 and a deckled curved edge 78 for creating deckled edges (FIGS. 73-74) by tearing paper lengthwise along the respective edges 76, 78.

FIGS. 8 and 9 illustrate a pair of embodiments of the cornering tool 22. The cornering tool 22 is used to cut notches into the paper to facilitate the construction of a rectangular box. The cornering tool 22 is preferably made from a substantially rigid yet transparent material such that the user may readily identify the correct positioning of the cornering tool 22. For example, in FIG. 8 a right-hand indicator 80 is face side out and readable while a corresponding left-hand indicator 82 is face side down on the reverse side of the cornering tool 22. In FIG. 8, the right-hand indicator 80 is readable and the left-hand indicator 82 is not. Accordingly, the cornering tool 22 as positioned in FIG. 8 is used to cut flaps out of the right-hand corners of the rectangular boxes as described herein. FIG. 9 illustrates the opposite positioning of the right-hand indicator 80 and the left-hand indicator 82. As shown in FIG. 9, the left-hand indicator 82 is face side out and readable while the right-hand indicator 80 is face side down and unreadable. In this configuration, the cornering tool 22 is used to cut flaps from the left-hand corners of the rectangular boxes described herein. The cornering tool 22 also includes a pair of grooves 84, 86 extending through the width of the cornering tool 22 to allow a flat, sharp blade to fit therein. A corner 87 of the cornering tool 22 is aligned at the corner of intersecting scorelines, as further described herein. Thereafter any cutting device capable of insertion within the grooves 84, 86 can cut a section out of the sidewalls of the rectangular box to form foldable flaps therein.

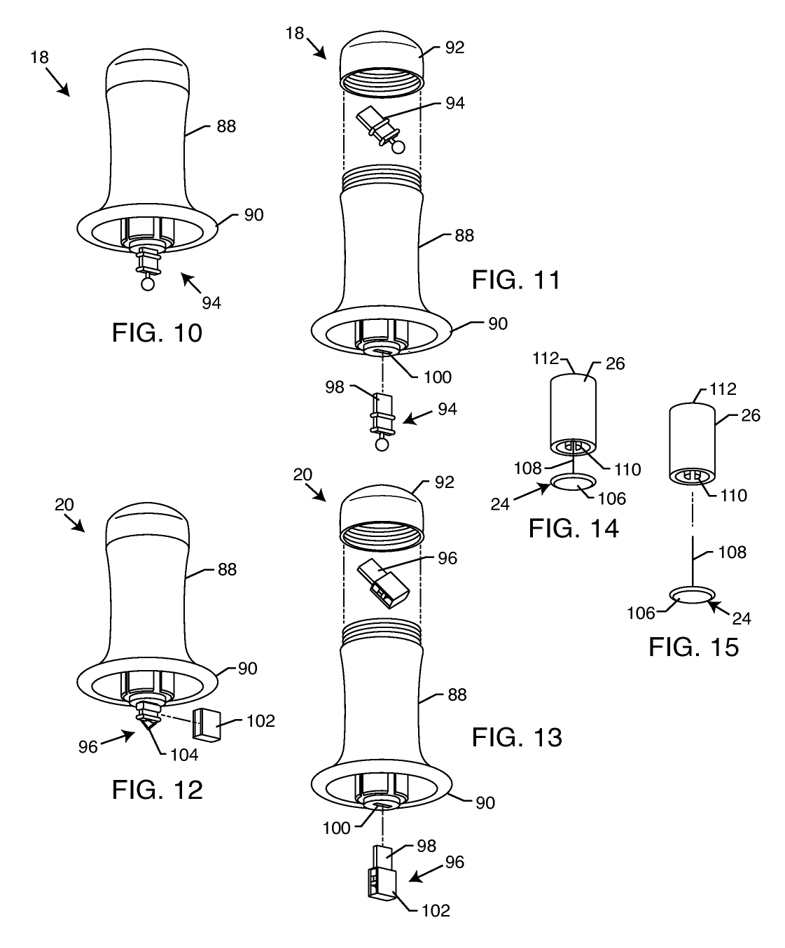

The scoring tool 18 and the cutting tool 20 are shown in FIGS. 10-11 and FIGS. 12-13, respectively. The scoring tool 18 and the cutting tool 20 are preferably color coded to match the colors of the cutting side 28 and the scoring side 30 of the double-sided mat 12, respectively. The scoring tool 18 and the cutting tool 20 each include a main body 88 having a bell-type curve to grip and support downward pressure about an extension 90 during cutting or scoring. The scoring tool 18 and the cutting tool 20 both also include a threaded cap 92 that threadingly engages the main body 88 to encapsulate a storage compartment (not shown). The storage compartment may retain additional scoring knobs 94 or cutting blades 96. The scoring knob 94 and the cutting blade 96 each have a substantially flat and rigid connector 98 (FIGS. 11 and 13) configured for slide-fit engagement with an insertion slot 100 formed at the base of the main body 88. Alternatively, the scoring knob 94 may be interchangeable with the cutting blade 96 in a universal tool having the insertion slot 100. But, it is preferred in the present invention that the scoring knob 94 only be used with the scoring tool 18 and the cutting blade 96 only be used with the cutting tool 20 to make use of the previously described color coding arrangement. Color coding the scoring tool 18 with the scoring side 30 and the cutting tool 20 with the cutting side 28 provides an immediate visual identification that the scoring knob 94 is used with the scoring side 30 and that the cutting blade 96 is used with the cutting side 28. Use of the cutting blade 96 with the scoring side 30 may damage the foam-like surface. The scoring knob 94 would also otherwise be unable to indent the cutting side 28 to properly form scorelines. The cutting blade 96 additionally includes a cover 102 that snaps over the base of a blade 104 to shield the blade 104 from exposure during periods of non-use. The cover 102 is preferably formed from plastic or a comparable resilient metal material that the blade 104 could not puncture or otherwise cut. As shown in more detail herein, the scoring knob 94 or the cutting blade 96 is inserted into either the straight channel 46 or one of the curved channels 66 during scoring or cutting, respectively.

FIGS. 14 and 15 illustrate the pin 24 and the corresponding cap 26. The pin 24 has a generally planar head 106 and a longitudinally extending point 108. The point 108 preferably has a diameter that snugly fits into the aperture 44 formed in the double-sided mat 12. Moreover, the point 108 should be capable of puncturing a hole through rigid paper crafting cardstock. Accordingly, the point 108 slides into and engages a receptacle 110 formed into the interior of the cap 26. The receptacle 110 may include a pair of indentations (not shown) for receiving the point 108 therein. The receptacle 110 may also taper inwardly toward a top portion 112 of the cap 26 to better engage and secure the point 108 therein. The cap 26 is used to cover the point 108 to prevent accidental pin prick injury during use of the pin 24 with the double-sided mat 12.

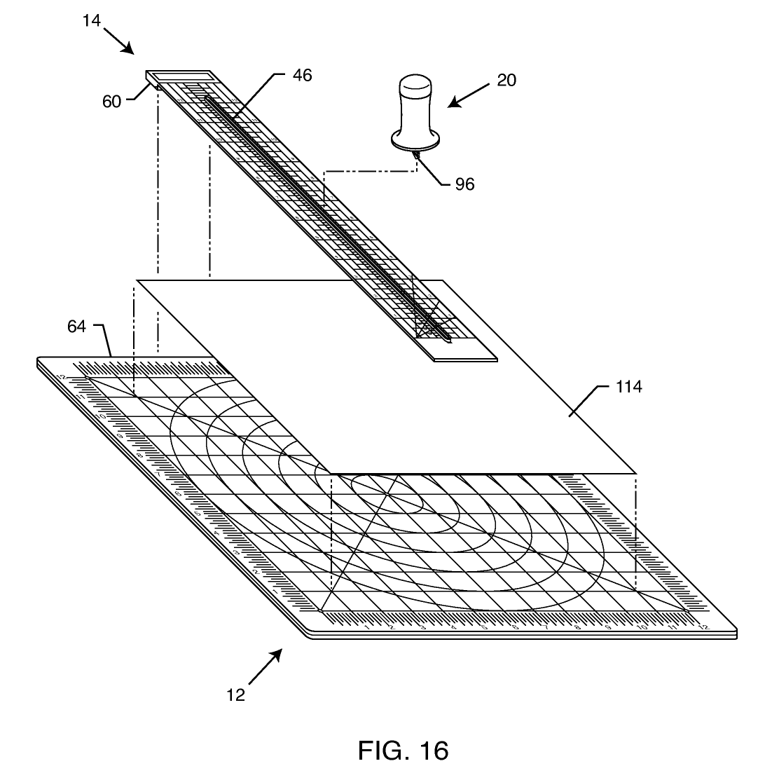

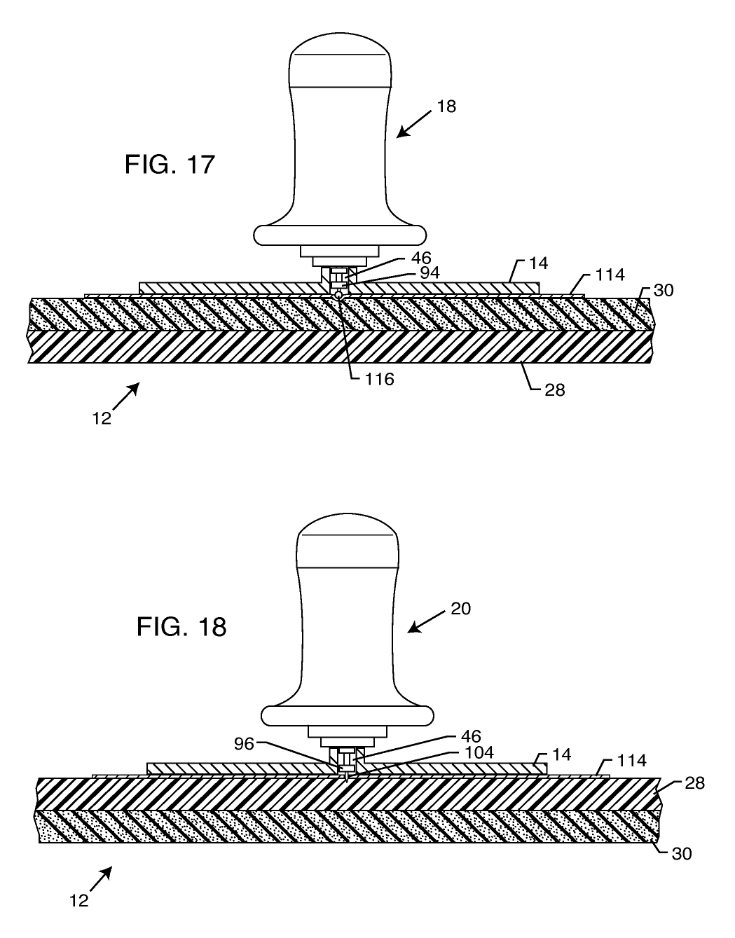

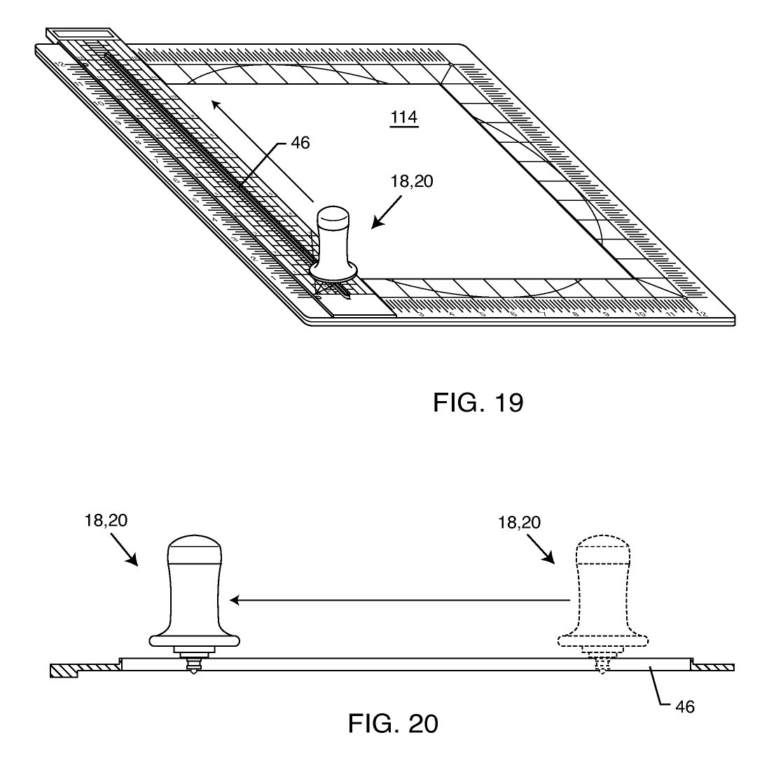

FIGS. 16-20 illustrate the general engagement of either the scoring tool 18 or the cutting tool 20 within the straight channel 46 of the straight ruler 14. Specifically, FIG. 16 illustrates alignment of the cutting blade 96 within the straight channel 46 of the straight ruler 14. Accordingly, the lip 60 of the straight ruler 14 is aligned flush with the side edge 64 of the double-sided mat 12. A piece of paper 114 is disposed between one of the sides 28, 30 of the double-sided mat 12 and the straight ruler 14. FIGS. 17 and 18 provide cross-sectional views of the placement of the scoring tool 18 and the cutting tool 20 within the channel 46 (or one of the channels 66) during scoring or cutting, respectively. In FIG. 17, the scoring knob 94 of the scoring tool 18 is disposed within the straight channel 46. As shown in the cross-sectional view, the scoring knob 94 is locked within the straight channel 46 to prevent sideways movement therein. Moreover, the curvature of the scoring knob 94 indents the paper 114 into the scoring side 30 to produce a scoreline 116. Likewise, FIG. 18 illustrates the cutting tool 20 having the cutting blade 96 disposed within the straight channel 46. Like the scoring knob 94, the cutting blade 96 is locked within the straight channel 46 to prevent sideways movement therein. The blade 104 extends through the channel 46 to contact the paper 114 for cutting the paper 114 against the substantially rigid cutting side 28. Note that the cutting side 28 does not flex under the pressure of the blade 104 as did the scoring side 30 in response to the pressure from the scoring knob 94. Furthermore, FIG. 19 illustrates a general perspective view of either the scoring tool 18 or the cutting tool 20 residing within the straight channel 46 in preparation for scoring or cutting the paper 114, respectively. FIG. 20 illustrates the tool 18, 20 sliding within the straight channel 46 along the corresponding directional arrows. As will be described more fully herein, such movement will either score or cut the corresponding paper 114 depending on the project.

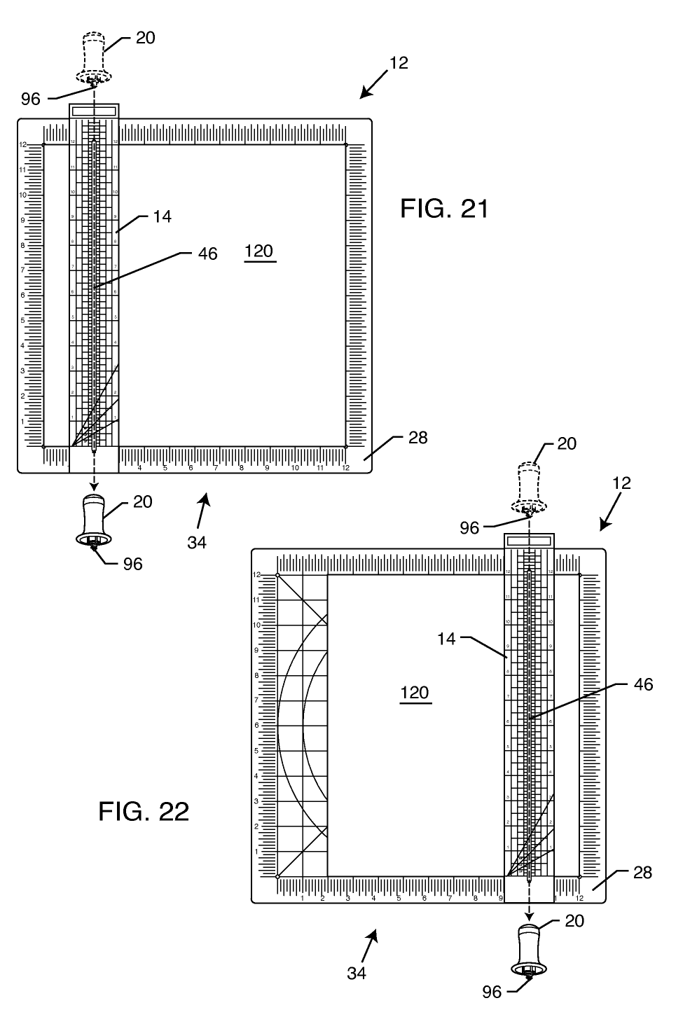

FIGS. 21-39 illustrate the construction of a basic box 118 (FIG. 39) via the paper crafting kit 10 of the present invention. To make the basic box 118, two sheets of cardstock having identical dimensions are required. The size of the blank cardstock can be calculated by using the height, width and length of the resulting basic box 118. For example, the width of the blank cardstock is equal to the width of the basic box 118 plus the height of a side of the basic box 118 multiplied by two. Likewise, the length of the blank cardstock equals the length of the basic box 118 plus the height of one side of the basic box 118 multiplied by two. Any type of cardstock may be used to make the basic box 118, including paper, cardboard, construction paper or vellum. If the cardstock blanks are not the desired size of the resulting box, the cardstock must initially be cut to the dimensions as calculated above.

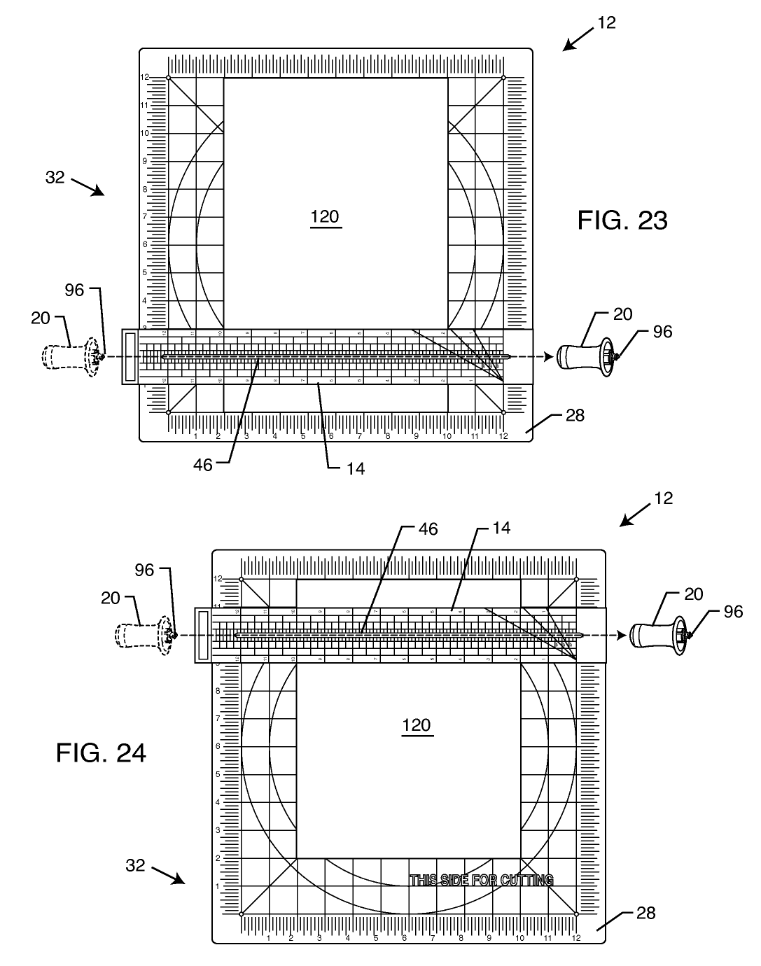

FIGS. 21-24 illustrate the initial steps for trimming cardstock to a desired size to make the basic box 118. In FIG. 21, a piece of cardstock 120 is disposed over the cutting side 28 of the double-sided mat 12. In this example, the cardstock 120 is twelve inches by twelve inches. A variety of cardstock sizes may be used with the present invention, including sizes that are larger than twelve inches by twelve inches. If the cardstock 120 is larger than the double-sided mat 12, then the cardstock 120 must be readjusted and cut again for the portions that may extend off the cutting side 28. In the present example, the cardstock 120 will be cut to a size of eight inches by eight inches to make a box having a width of six inches, a length of six inches and a height of one-inch. In FIG. 21, the straight ruler 14 is aligned at the two-inch marking of the horizontal markings 34. The lip 60 (not shown in FIG. 21) engages the side edge 64 (FIG. 1) to ensure accurate cutting by the cutting tool 20 along the two-inch line. The cutting blade 96 of the cutting tool 20 is inserted into the straight channel 46 to cut the cardstock 120 along the two-inch line using the process generally shown in FIG. 18. The two inches of the cardstock 120 cut off in FIG. 21 are removed and are unneeded for the creation of the basic box 118. FIG. 22 repeats the process described for FIG. 21, wherein the straight ruler 14 is aligned at the ten-inch marking on the horizontal markings 34. The right two inches of the cardstock 120 are cut off as the cutting blade 96 of the cutting tool 20 is inserted into the straight channel 46 and moved therein in the manner described in accordance with FIG. 18. The process is again repeated in FIGS. 23 and 24 to cut off two inches from the top and bottom portions of the cardstock 120. In these embodiments, the straight ruler 14 is aligned with the two-inch marking and the ten-inch marking of the vertical markings 32 (FIG. 24). Again, the cutting blade 96 is inserted into the straight channel 46 of the straight ruler 14 such that the cutting tool 20 is capable of cutting the cardstock 120 in accordance with the present invention. The lip 60 of the straight ruler 14 should be snug against any of the four side edges 64 during the cutting process to ensure accurate and straight cutting. Alternatively, the cardstock 120 may be rotated ninety degrees after each cut such that the straight ruler 14 remains aligned with the two-inch marking of the vertical markings 34 as in FIG. 21. The cardstock 120 is aligned in the lower left-hand corner of the vertical markings 32 and the horizontal markings 34 during this process. The processes shown and described in FIGS. 21-24 are then repeated for the second piece of cardstock to ensure that both sheets of cardstock are substantially identical in size. The accurate construction of the basic box 118 depends directly on the dimensions of the blank cardstock.

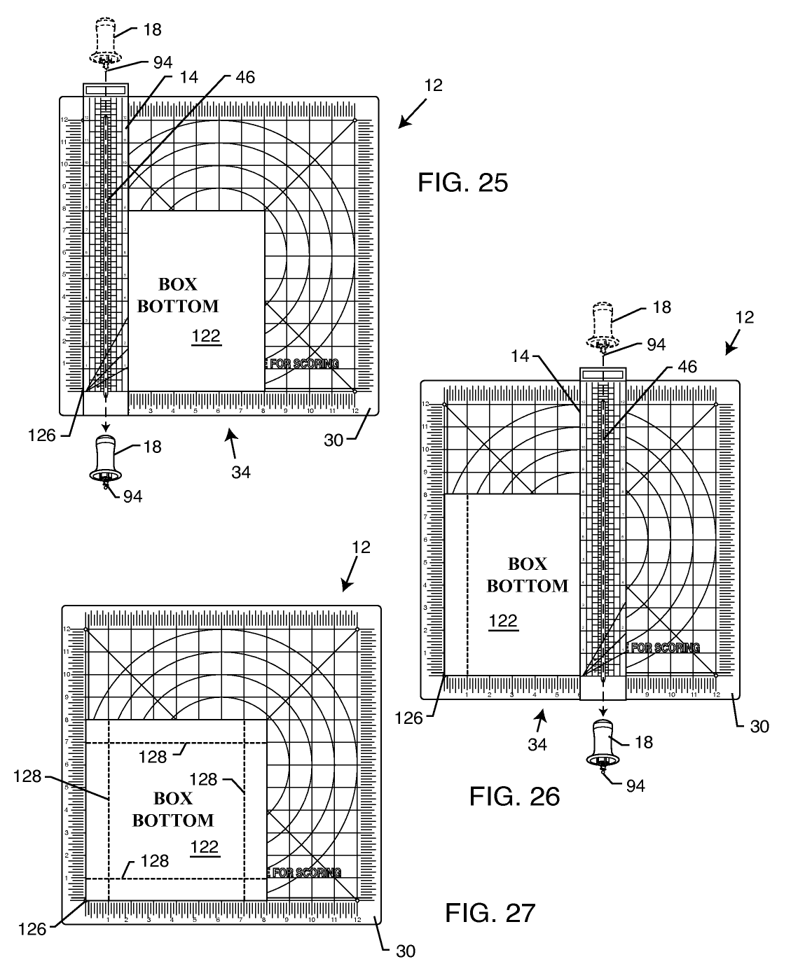

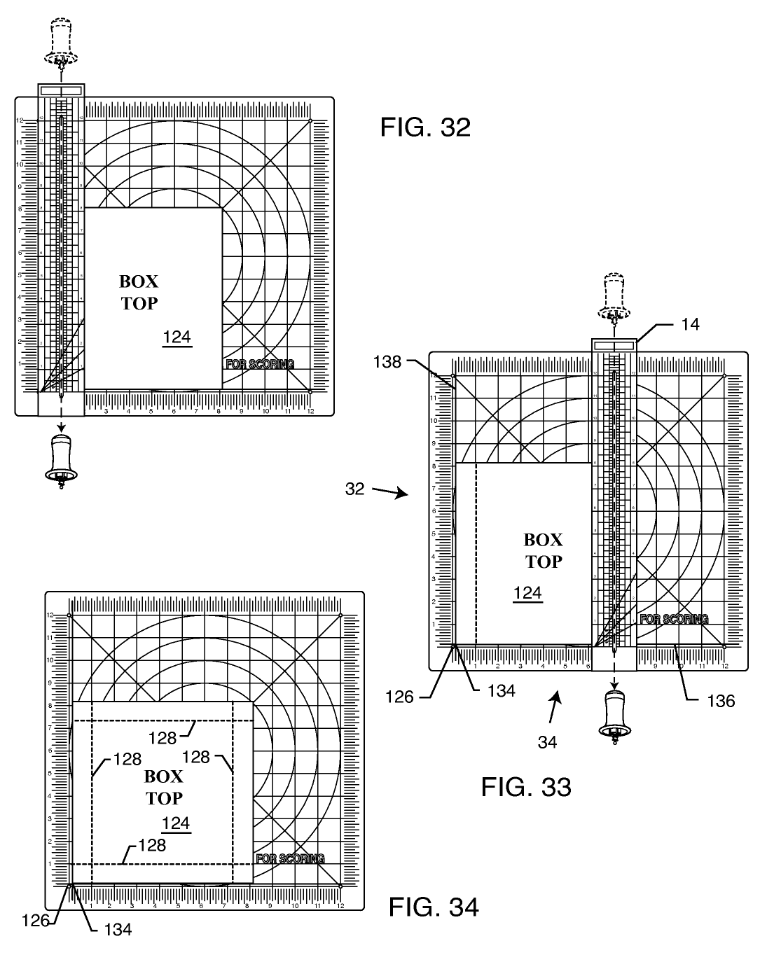

FIGS. 25-31 illustrate formation of a basic box bottom 122 and FIGS. 32-36 illustrate formation of a basic box top 124. First, the double-sided mat 12 is positioned such that the scoring side 30 is face up. The lower left-hand corner of the box bottom 122 is aligned with a zero point 126, as best shown in FIG. 26. The straight ruler 14 is then aligned with the one-inch marking of the horizontal markings 34 to score the basic box 118 having a one-inch height. The scoring knob 94 of the scoring tool 18 is inserted into the straight channel 46 of the straight ruler 14 to create a scoreline (denoted by the dotted line in FIG. 26) extending the length of the box bottom 122. If the cardstock 120 is larger than twelve inches on either side, the cardstock 120 is repositioned on the scoring surface 30 of the double-sided mat 12 to score the entire length of the box bottom 122. The process is repeated by aligning the straight ruler 14 with the seven-inch marking (one-inch to the left of the eight-inch marking of the outer edge) of the horizontal markings 34. The scoring knob 94 of the scoring tool 18 is then used in FIG. 26 in accordance with the prior embodiments to create a scoreline one-inch from the edge of the basic box bottom 122. Accordingly, the scoring process is repeated for all four sides of the basic box bottom 122. Alternatively, the basic box bottom 122 may be rotated ninety degrees and repositioned at the zero point 126 to score along the one-inch marking of the horizontal markings 34 instead of moving the ruler. The basic box bottom 122 having the respective scorelines 128 formed therein is shown in FIG. 27.

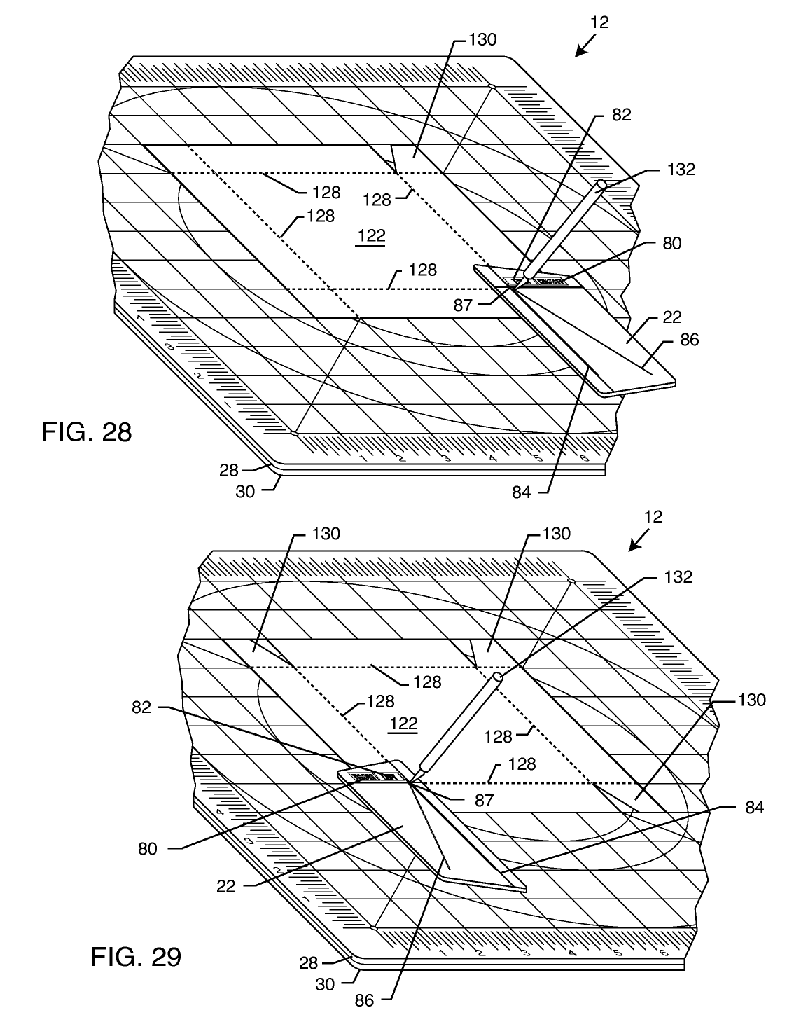

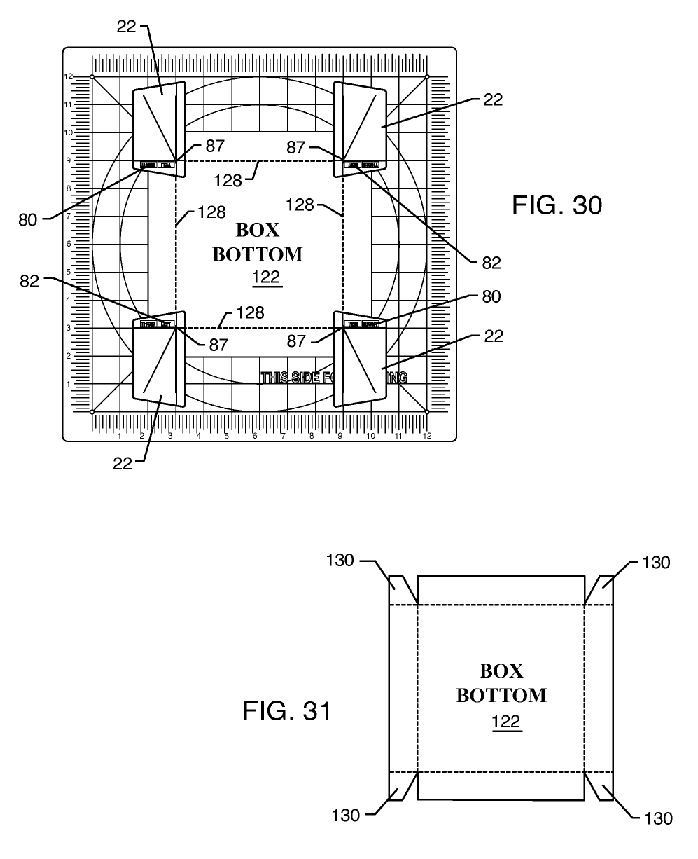

Next, the basic box bottom 122 must be notched to create a set of flaps 130 that allow the cardstock 120 to fold together along the scorelines 128. First, the double-sided mat 12 is flipped to the cutting side 28. Then, the cornering tool 22 is placed over the basic box bottom 122 and the corner 87 is aligned with the corner of intersecting scorelines 128 as generally shown in FIGS. 28-29. In FIG. 28, the right side of the basic box bottom 122 is notched. Accordingly, the right-hand indicator 80 of the cornering tool 22 is face side up while the left-hand indicator 82 is face side down. The hand indicators 80, 82 better ensure that the cornering tool 22 is used to notch the correct corner of the basic box bottom 122. Once the corner 87 of the cornering tool 22 is aligned with the intersecting scorelines 128, a crafting knife 132 is inserted into the grooves 84, 86 to cut out a section from the basic box bottom 122. The cornering tool 22 is then turned over such that the left-hand indicator 82 is face up and the right-hand indicator 80 is face down to notch the left-hand corner of the basic box bottom 122 as shown in FIG. 29. FIG. 30 illustrates the proper alignment of the cornering tool 22 for each of the four corners of the basic box bottom 122. The corner 87 is appropriately aligned with respective intersection points of the scorelines 128. The right-hand indicator 80 is face side up for the corresponding right-hand corners of the basic box bottom 122 and the left-hand indicator 82 is face side up for the corresponding left-hand corners of the basic box bottom 122. The basic box bottom 122 in FIG. 31 illustrates the set of properly formed flaps 130 in accordance with the present invention. The basic box bottom 122 is now ready for folding.

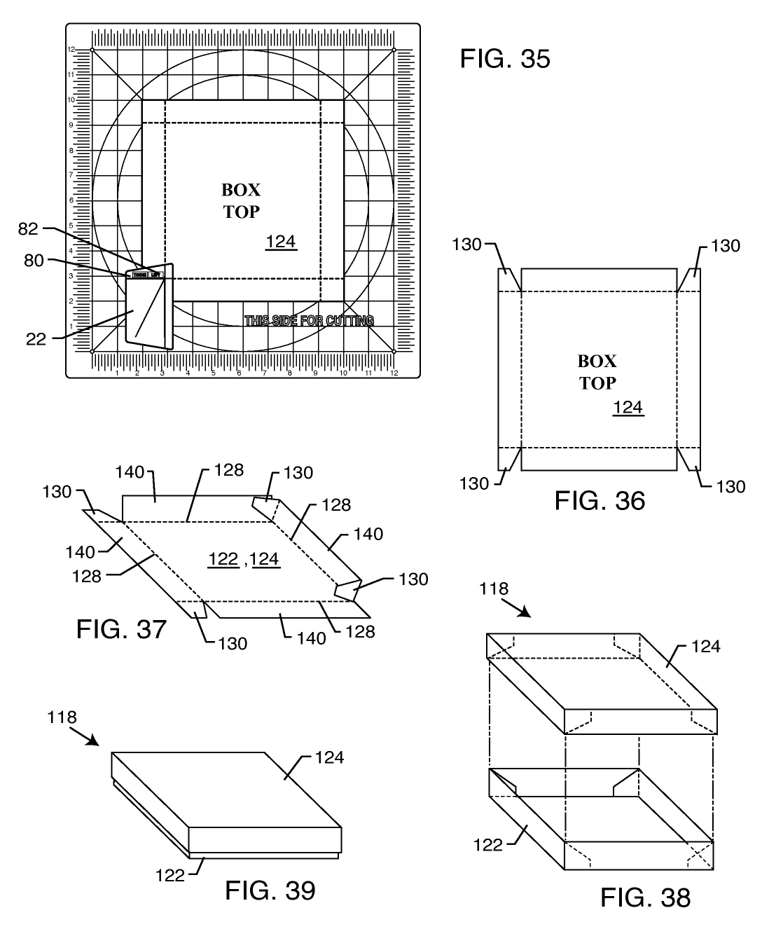

The process for creating the basic box top 124 is similar to the process for creating the basic box bottom 122 as illustrated in FIGS. 32-36. The major difference between forming the basic box bottom 122 and the basic box top 124 is that the basic box top 124 is aligned at the offset point 134 instead of the zero point 126, best shown relative to one another in FIG. 33. The offset point 134 represents the intersection of a horizontal offset marking 136 and a vertical offset marking 138. The offset markings 136, 138 are preferably offset from the corresponding parallel horizontal and vertical markings that intersect at the zero point 126 by one-eighth inch. Alignment with the offset point 134 ensures that the basic box top 124 has a slightly larger base length and width than the base length and width of the basic box bottom 122. In this example, the difference in length is one-eighth inch and the difference in width is also one-eighth inch. The process is preferably repeated for each side of the basic box top 124 by rotating the basic box top 124 ninety degrees after each scoreline is created and aligning the corresponding basic box top 124 with the offset point 134 and the corresponding offset markings 136, 138. Alternatively, the sidewalls of the basic box top 124 may be created using the vertical markings 32 and the horizontal markings 34 by offsetting the straight ruler 14 seven-eighths inch from each corresponding edge of the basic box top 124. In general, the straight ruler 14 should be used in conjunction with the markings 32, 34 to form the basic box top 124 having a base width and a base height one-eighth inch greater than the base width and the base height of the basic box bottom 122. The additional one-eighth inch in length and width of the box top base provides the necessary tolerance such that the box top may fit over and encompass the box bottom. This formula works for boxes of all different heights. Alternatively, the cardstock could be inwardly offset from the horizontal offset marking 136 or the vertical offset marking 138, thereby decreasing the one-eighth inch offset, to provide a tighter fit between the box tops and the box bottoms, in general. FIG. 34 illustrates the basic box top 124 having a plurality of the scorelines 128 formed via the above processes. FIG. 35 is a basic illustration of the cornering tool 22 aligned with the lower left-hand corner of the basic box top 124. Accordingly, the left-hand indicator 82 is face out and the right-hand indicator 80 face down. The set of flaps 130 shown in FIG. 36 are formed according to same process described and shown in FIGS. 28-30 for the basic box bottom 122.

Folding the basic box bottom 122 and the basic box top 124 is shown generally in FIG. 37. A set of sidewalls 140 formed by the scorelines 128 and the flaps 130 are folded about the scorelines 128 as shown in FIG. 37. The flaps 130 and the sidewalls 140 fold to the interior thereof. An adhesive may be applied to the outside of the flaps 130 or the interior of the sidewalls 140 to adhere the flaps 130 to the sidewalls 140 to form the three-dimensional structure shown in FIG. 38. Accordingly, the basic box top 124 is capable of fitting over and engaging the basic box bottom 122 to form the basic box 118 shown in FIG. 39.

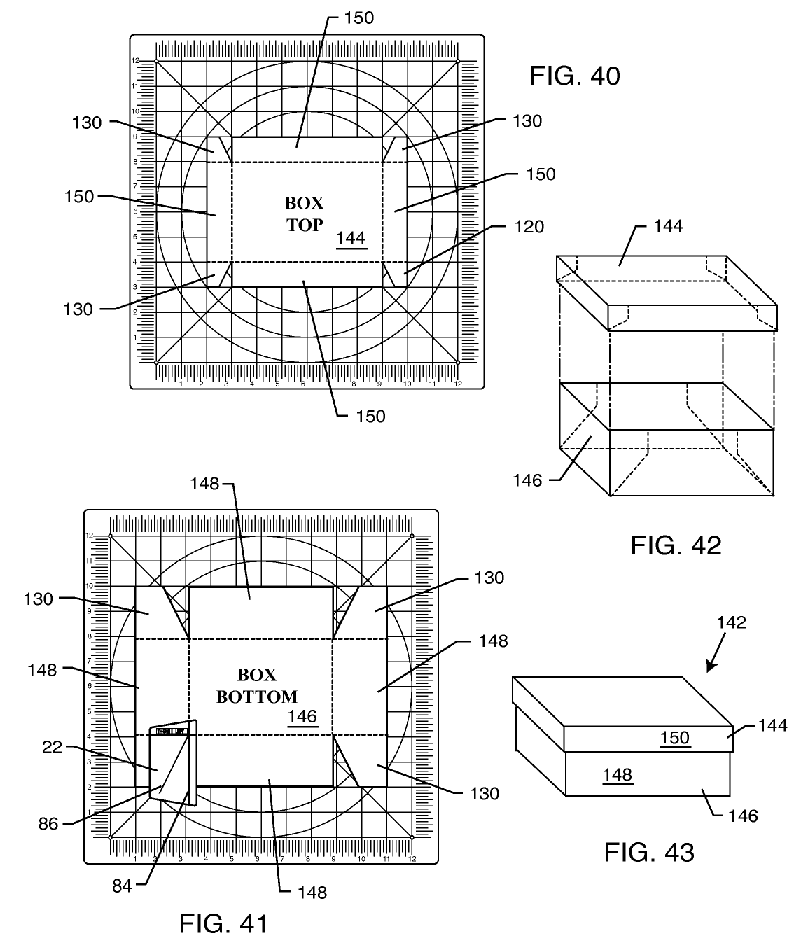

FIGS. 40-43 illustrate construction of a short top box 142, specifically shown in perspective view in FIG. 43. The formation of the short top box 142 is nearly identical to the process for forming the basic box 118. The only difference is that the cardstock used to make the box top is not identical to the size of the box bottom. The dimensions of the two sheets of cardstock for the short top box 142 are calculated in a similar manner as the basic box 118. A short box top 144 and a tall box bottom 146 are generally shown in relative dimensions in FIGS. 40 and 41, respectively. The major difference in cardstock size between the short box top 144 and the tall box bottom 146 is the height of the sidewalls. Accordingly, the box bottom sidewalls 148 are relatively higher than the box top sidewalls 150. The flaps 130 of the short box top 144 and the tall box bottom 146 are formed via the cornering tool 22 (generally shown in FIG. 41) in accordance with the previously described processes. For boxes that have sidewalls extending beyond the grooves 84, 86 of the cornering tool 22, the excess material may either be cut with scissors or another cutting device such as a knife. Accordingly, the short box top 144 and the tall box bottom 146 are formed by folding the box bottom sidewalls 148, the box top sidewalls 150 and the corresponding flaps 130 toward one another as was shown and described in FIG. 37 for the basic box 118. Likewise, adhesive is applied to the exterior of the flaps 130 or the interior of the sidewalls 148, 150 to adhere the flaps 130 to the corresponding sidewalls 148, 150. As shown in FIGS. 42 and 43, the short box top 144 fits over and engages the tall box bottom 146. The difference in height between the box top sidewalls 150 and the box bottom sidewalls 148 is best shown in FIG. 43.

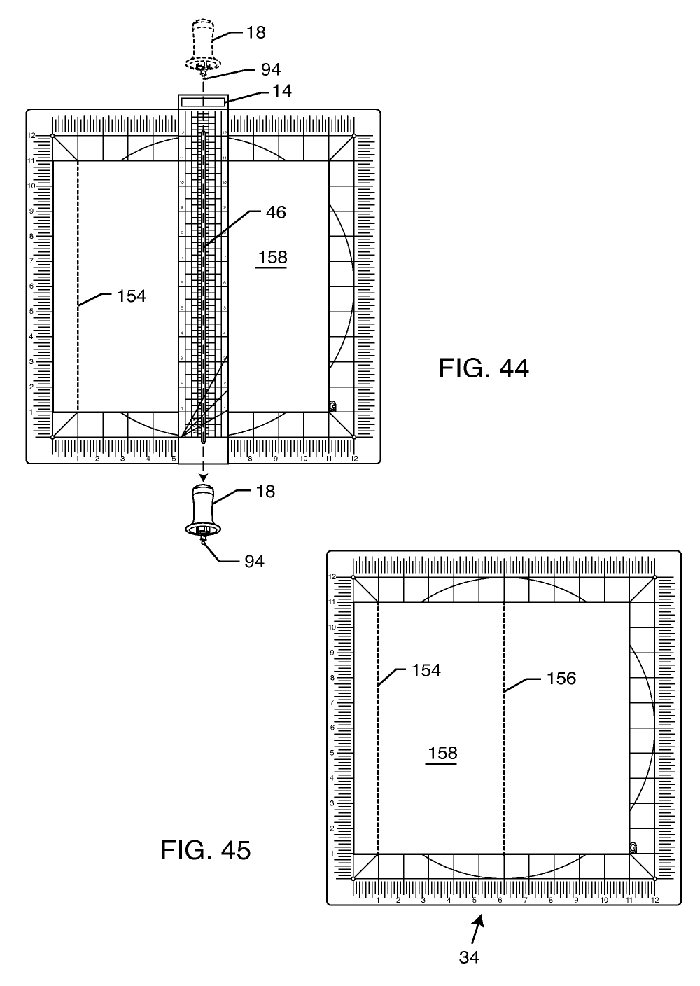

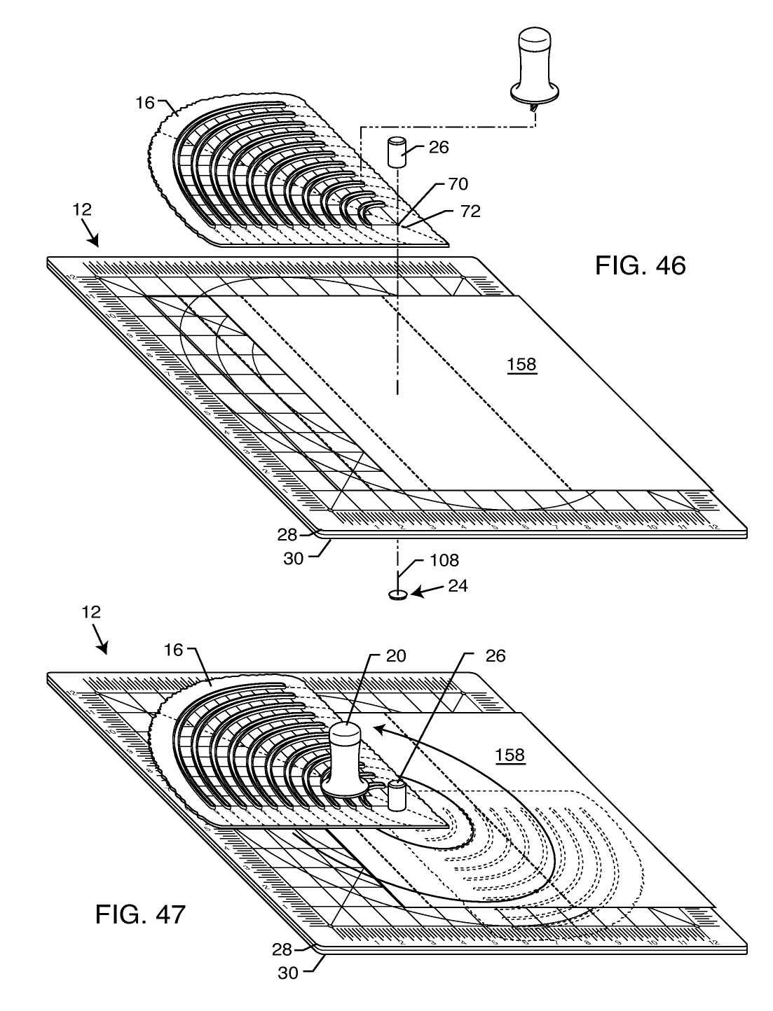

FIGS. 44-60 illustrate formation of a pillow box 152 (FIG. 60). The size of the blank cardstock needed to make the pillow box 152 again depends on the desired final size of the pillow box 152. The width of the blank cardstock is equal to the finished width of the pillow box 152 multiplied by two plus one-inch for a glue tab. The total length of the blank cardstock is equal to the length of the pillow box 152 plus the depth of the pillow box 152 multiplied by two. A one-inch glue tab is preferred for larger pillow boxes, but may be smaller depending on the overall size of the pillow box. An example pillow box 152 that has a final width of five inches, a height of one-inch and a length of eight inches would be formed from blank cardstock being eleven inches in width by ten inches in length. The cardstock may be pre-sized or cut to a specific size according to the processes previously disclosed.

FIG. 44 shows the initial steps of creating the pillow box 152 shown in FIG. 60. The first step in creating the pillow box 152 is to create a tab scoreline 154 and a center scoreline 156. In this example, the tab scoreline 154 is formed one-inch from the left-hand border of a cardstock 158. The center scoreline 156 then splits the remaining section of the cardstock 158 in half at the six-inch marking of the horizontal markings 34. The scorelines 154, 156 are created using the already described processes wherein the scoring knob 94 of the scoring tool 18 is inserted into the straight channel 46 of the straight ruler 14 as generally shown in FIG. 44. FIG. 45 shows the completed tab scoreline 154 and the completed center scoreline 156.

An optional window 160 (best shown in FIG. 49) may be formed in one or more sides of the pillow box 152 prior to completion. The window 160 is ideal for providing a preview to the contents of the pillow box 152. For example, cellophane may be glued to the inside of the pillow box 152 to allow viewing of the contents of the pillow box 152, such as cookies, candies, popcorn or other gifts. Alternatively, a photograph may be attached to the interior of the pillow box 152 for display through the window 160. Other creative features may be added to the cardstock 158 such as embossing, paint, rubber stamps, photos, decorative paper or other type of fabric.

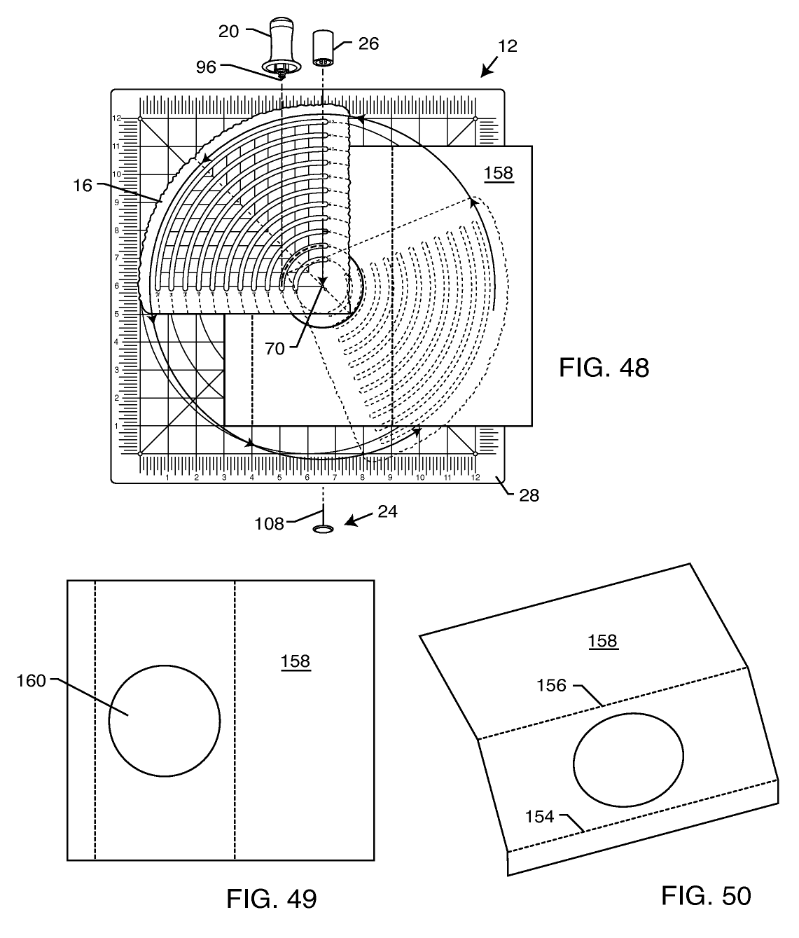

To create the window 160, the double-sided mat 12 is positioned such that the cutting side 28 is face side up and the scoring side 30 is face side down. Next, the pin 24 is inserted through the aperture 44 formed in the double-sided mat 12 (shown in FIG. 3). The cardstock 158 is then placed on top of the cutting side 28 such that the point 108 of the pin 24 pokes a hole in one portion of the cardstock 158. The point 108 is then extended through either the lower aperture 70 or the upper aperture 72 in the curved ruler 16. Preferably, the point 108 extends through the lower aperture 70. Thereafter, the cap 26 is placed over the point 108 to prevent inadvertent pin prick injury. The curved ruler 16 is rotatable about the point 108 as threaded through the lower aperture 70. Varyingly sized windows 160 may be formed in the cardstock 158 pending that the window 160 does not extend beyond the tab scoreline 154 or the center scoreline 156. FIGS. 47 and 48 illustrate the process of cutting the window 160 by inserting the cutting blade 96 of the cutting tool 20 into the three-inch curved channel 66. The curved ruler 16 is then rotated about the point 108 to cut out the window 160 having a three-inch radius. The curved ruler 16 may be rotated clockwise or counterclockwise (as shown in FIGS. 47-48) to make the window. FIG. 49 illustrates the window 160 cut out from the cardstock 158. Thereafter, the cardstock 158 is folded about the tab scoreline 154 and the center scoreline 156 as shown in FIG. 50.

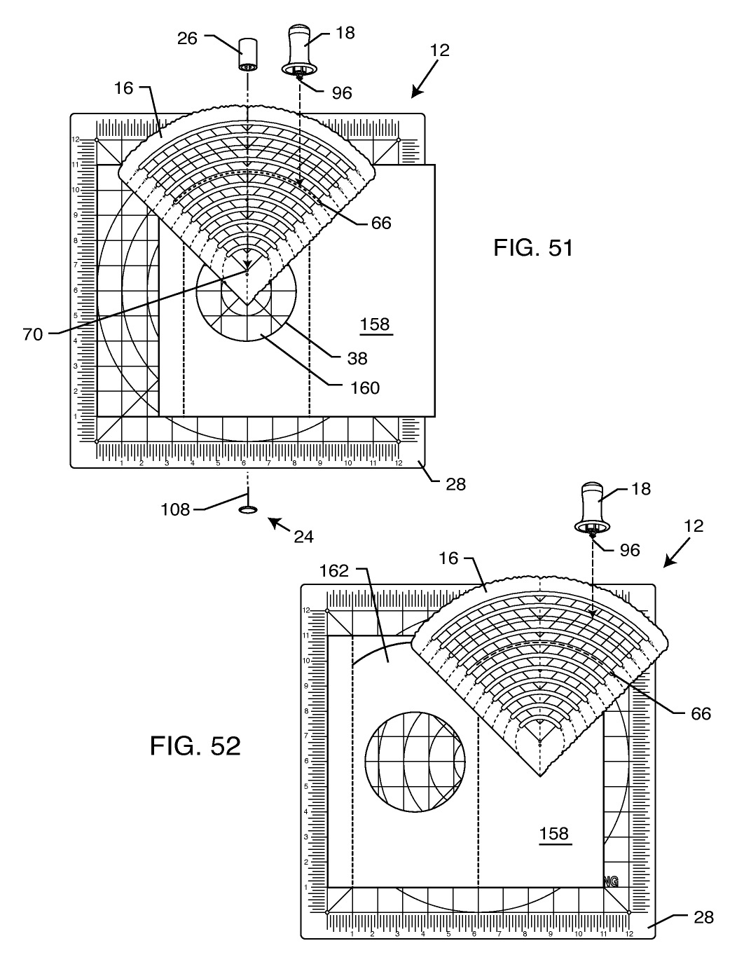

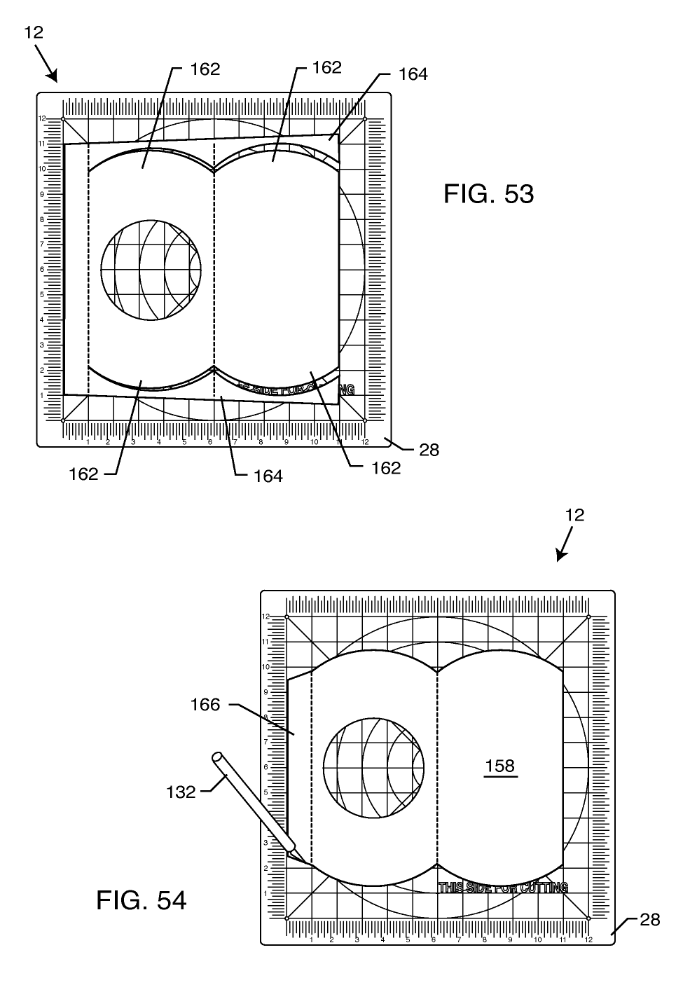

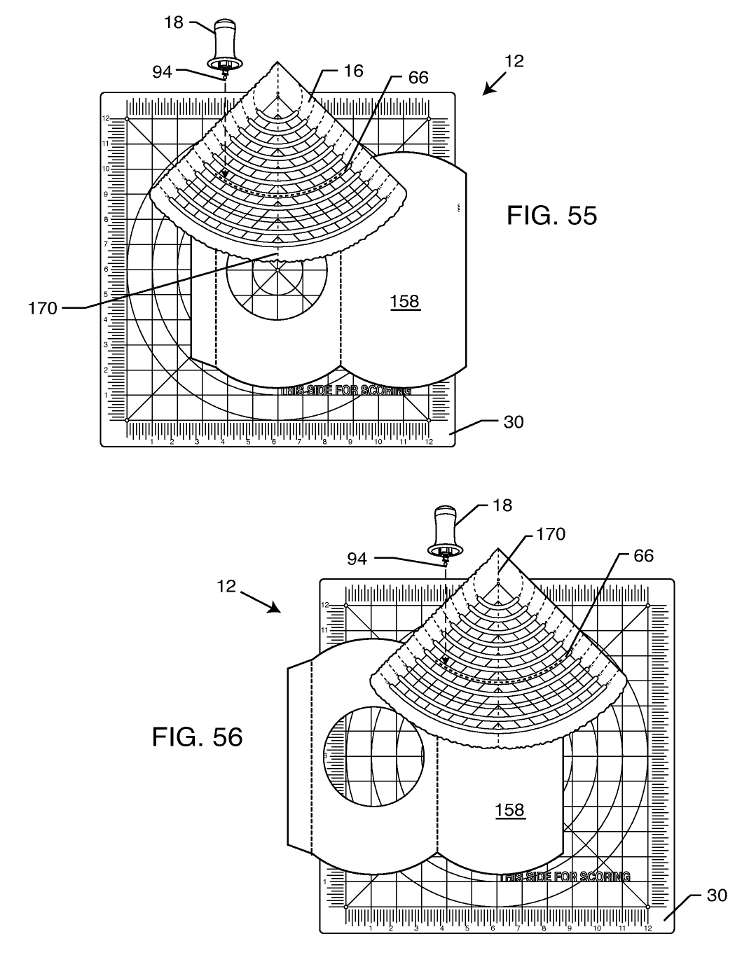

The next step in creating the pillow box 152 is to cut out a set of curved ends 162 (FIG. 53). The curved ends 162 may be formed by a variety of processes. For example, for a pillow box 152 having a specific height, the cardstock 158 should be marked with the straight ruler 14 offset from each respective edge thereof. If a specific height is unimportant, then the formation of any arc length is sufficient. The curved ends 162 may be formed by specific alignment of the curved ruler 16 with the cardstock 158 (FIGS. 51 and 55) or cut by hand (FIGS. 52 and 56). In FIG. 51, the point 108 of the pin 24 is inserted through the aperture 44 of the double-sided mat 12 and through the lower aperture 70 of the curved ruler 16. Accordingly, the point 108 is covered by the cap 26. The cardstock 158 is aligned within the center of the double-sided mat 12 with any of the previously described alignment processes. Preferably, the midpoint along the length of the window side of the cardstock 158 is aligned at the six-inch marking, as shown in FIG. 55. The cutting blade 96 of the scoring tool 18 is then inserted into the eight-inch curved channel 66 of the curved ruler 16 to form the first curved end 162 as shown in FIG. 52. Alternatively, the curved end 162 may be formed by simply placing the curved ruler 16 on the cardstock 158 by hand (aligned with a centerline 170) to create the desired curved end 162 with the scoring tool 18, as previously described. The process is repeated for the non-window side of the cardstock 158.

A pair of scrap pieces 164 result from cutting out the curved ends 162. FIG. 53 shows the scrap pieces 164 relative to the curved ends 162. The scrap pieces 164 may be cut off by cutting the excess material with the crafting knife 132 or other sharp device such as scissors. The scrap pieces 164 should be trimmed toward the interior as shown in FIG. 54 such that a flap 166 fits inside the pillow box 152 when finally formed.

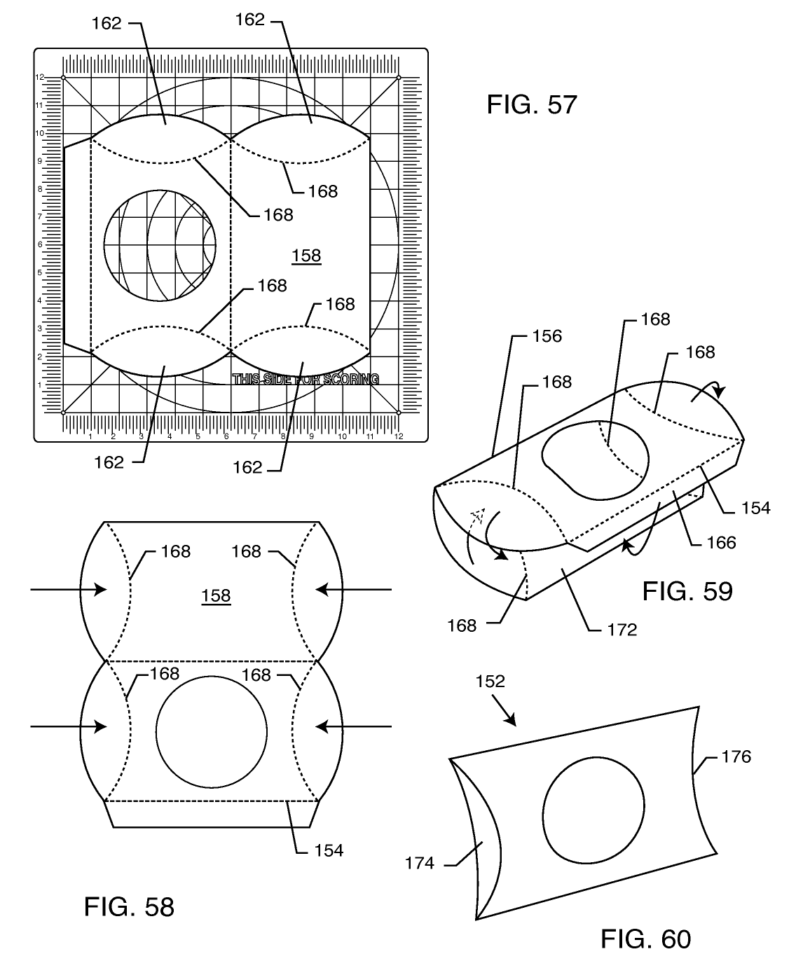

Next, FIGS. 55-57 illustrate the formation of a set of curved scorelines 168 that define the curved ends 162. The same eight-inch curved channel 66, as was used to cut the curved ends 162, is used for scoring. Here, the double-sided mat 12 is positioned such that the scoring side 30 is face side up and the cutting side 28 is face side down. The centerline 170 of the curved ruler 16 is aligned with the midpoint along the length of each section of the cardstock 158 as shown in FIGS. 55-56. The scoring knob 94 of the scoring tool 18 is inserted into the curved channel 66 to form the curved scorelines 168 as best shown in FIG. 57. The process shown in FIGS. 55-56 is repeated for all four sides of the cardstock 158. The cardstock 158 is then folded about the curved scorelines 168 along the directional arrows shown in FIG. 58. Additionally, the cardstock 158 is folded about the tab scoreline 154 and the center scoreline 156 as generally shown in FIG. 59. The flap 166 is correspondingly adhered to a bottom portion 172 of the pillow box 152 and each of the curved ends 162 are adhered to one another at a front end 174 and a back end 176 thereof. The adhesive may include double-sided tape or glue. The curved ends 162 are adhered to one another after being folded inwardly and pressed up against one another. Thereafter, the cardstock 158 is held together as the three-dimensional pillow box 152 shown in FIG. 60.

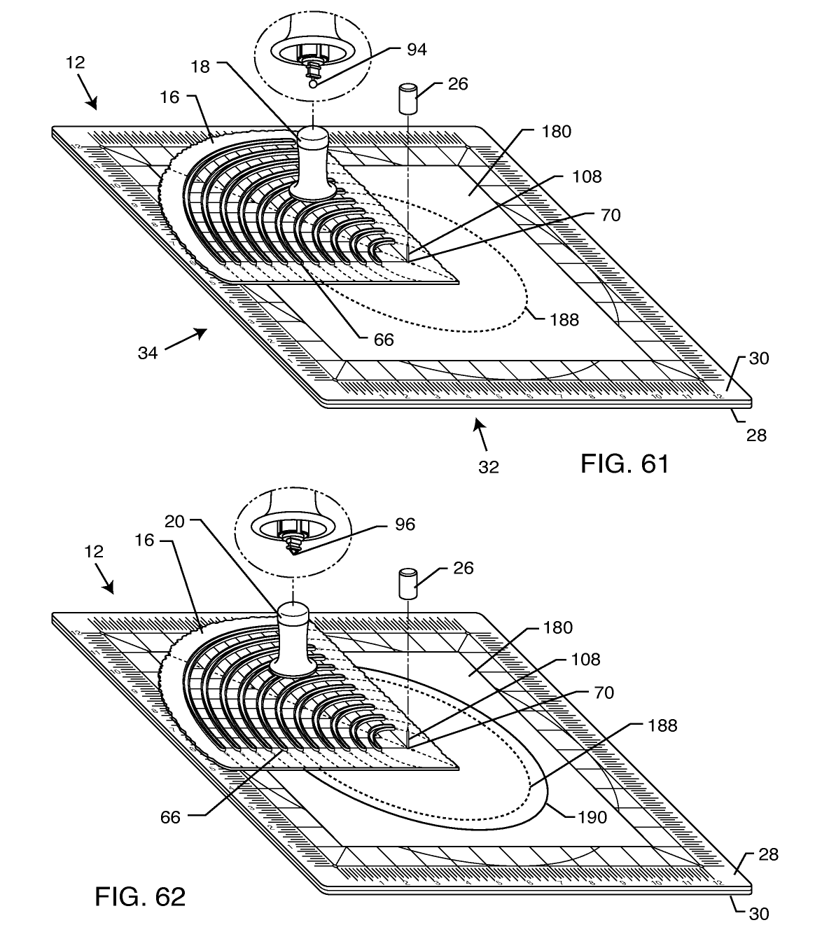

The paper crafting kit 10 of the present invention is also capable of producing a round box 178 as shown in FIG. 72. The steps for creating the round box 178 are generally shown in FIGS. 61-72. The paper crafting kit 10 of present invention is capable of making round boxes from two inches in diameter to eleven inches in diameter. The height of the box is virtually unlimited. The cardstock used to make the round box 178 may be rubber stamped, embossed, painted or personalized before assembly. After assembly, the round box 178 could be embellished with photos, tags, stickers or other fibers.

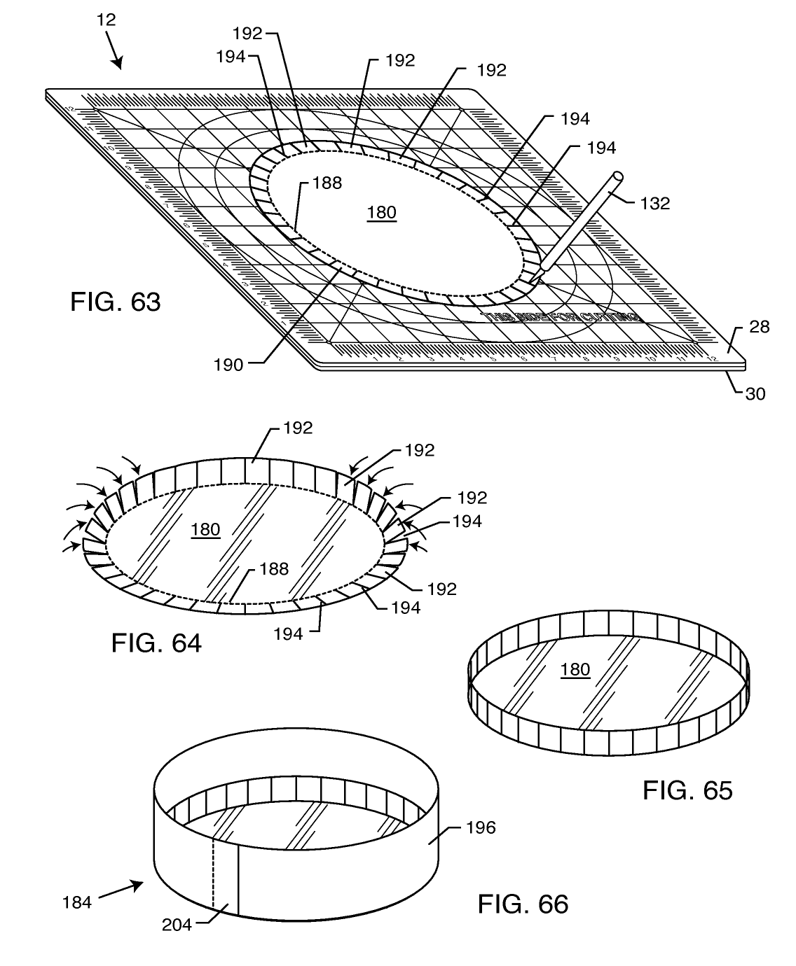

The formation of the round box 178 requires a bottom cardstock 180 and a top cardstock 182 dimensioned to form a round box bottom 184 and a round box top 186 of equal size. The dimensions of the corresponding blank cardstock 180, 182 should be the diameter of the desired round box 178, including additional material for tolerance. Preferably the cardstock 180, 182 is three inches greater in height and width than the diameter of the resulting round box 178. But, the cardstock 180, 182 may be two inches greater in height and width than the diameter of the resulting round box 178 to provide for a one inch lip. Otherwise, the cardstock 180, 182 could be any size. The bottom cardstock 180 and the top cardstock 182 may be pre-sized or otherwise cut to the desired dimensions by any of the previously described processes. Although, it is preferred that the blank cardstock 180, 182 be square. To form the round box bottom 184, the bottom cardstock 180 is placed on the scoring side 30 of the double-sided mat 12. The center of the bottom cardstock 180 is aligned with the double-sided mat 12 by any of the markings 32, 34. The point 108 of the pin 26 (not shown in FIG. 61) is inserted through the double-sided mat 12, through the center of the bottom cardstock 180 and through the lower aperture 70 of the curved ruler 16. The point 108 is covered with the cap 26. Thereafter, the scoring knob 94 of the scoring tool 18 is inserted into one of the curved channels 66, e.g. the seven-inch curved channel 66 in FIG. 61, to score the round box 178 having a seven-inch radius. The curved ruler 16 may be rotated clockwise or counterclockwise about the point 108 to score a box bottom scoreline 188 in the bottom cardstock 180. Next, the double-sided mat 12 is flipped over such that cutting side 28 is face side up and the scoring side 30 is face side down. The bottom cardstock 180 is then again centered on the cutting side 28 using the same previously described process. The point 108 of the pin 24 is inserted through the aperture 44 in the double-sided mat 12, through the hole previously formed in the bottom cardstock 180 and through the lower aperture 70 of the curved ruler 16. The cap 26 is then placed over the point 108 for safety. The cutting blade 96 of the cutting tool 20 is inserted into the eight-inch curved channel 66 to make a box bottom cut 190 to the exterior of the bottom cardstock 180. Note that the box bottom cut 190 is made at a diameter one-inch greater than the box bottom scoreline 188 created in FIG. 61. After cutting the box bottom cut 190, a plurality of flaps 192 are formed in the bottom cardstock 180 by cutting a plurality of slices 194 (FIG. 63) perpendicular to the box bottom scoreline 188 and extending to the edge of the box bottom cut 190. The slices 194 may be cut with the crafting knife 132 as shown in FIG. 63 or any other sharp device such as scissors. Each of the flaps 192 are bent about the box bottom scoreline 188 (FIG. 64), as separated by the slices 194. The flaps 192 are secured to an elongated box bottom strip 196 around the circumference of the bottom cardstock 180 to form the round box bottom 184 shown in FIG. 66. The box bottom strip 196 should be at least one-inch wide and should have a length greater than the circumference of the box bottom scoreline 188 formed in FIG. 61. The width of the box bottom strip 196 determines the effective height of the round box bottom 184. An adhesive is applied along the length of one edge of the box bottom strip 196 for adherence to the plurality of now extending upwardly from the base of the bottom cardstock 180 shown in FIG. 65.

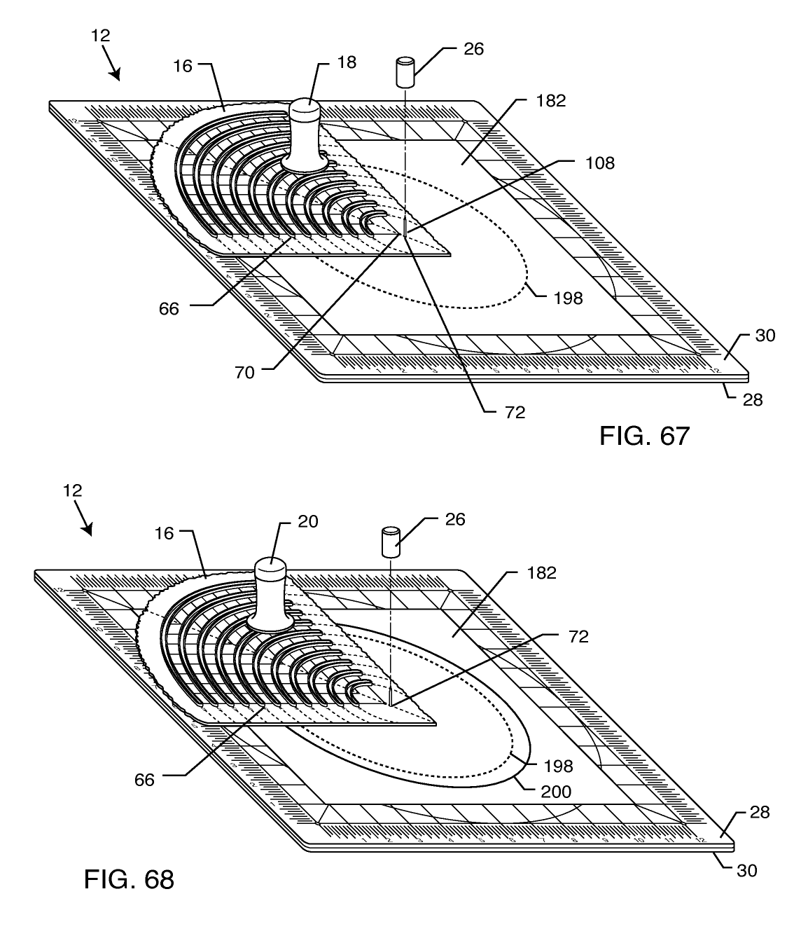

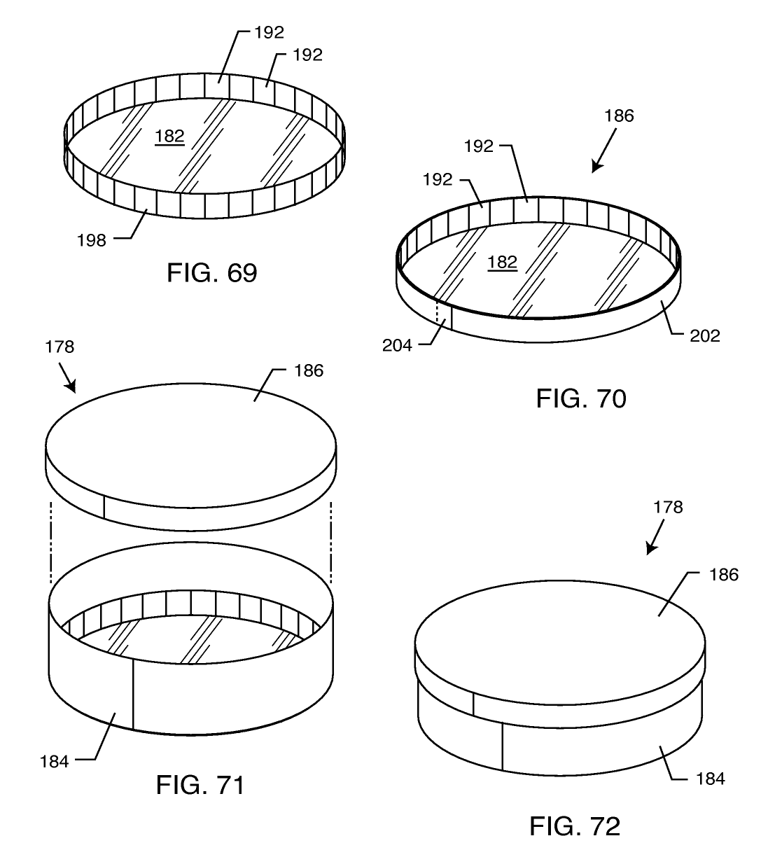

The process for forming the round box top 186 from the top cardstock 182 is similar to the process for forming the round box bottom 184 from the bottom cardstock 180. As generally shown in FIG. 67, the top cardstock 182 is disposed over the scoring side 30 of the double-sided mat 12. The point 108 is inserted through the aperture 44 of the double-sided mat 12 and pokes a hole through the center of the top cardstock 182. The top cardstock 182 is centered on the double-sided mat 12 according to any of the previously described processes. The cap 26 covers the point 108 to prevent inadvertent injury during use of the paper crafting kit 10 of the present invention. In this embodiment, the point 108 is inserted through the upper aperture 72 of the curved ruler 16 instead of the lower aperture 70. The upper aperture 72 is offset from the lower aperture 70 to provide the requisite tolerance such that the round box top 186 will fit over the round box bottom 184 as shown generally in FIG. 72. In other words, the round box top 186 will have a slightly larger diameter (preferably one-eighth inch) relative to the round box bottom 184. The round box top 186 is scored from the top cardstock 182 in FIG. 67 by inserting the scoring tool 18 into the same curved channel 66 as when scoring the round box bottom 184. Then, the double-sided mat 12 is flipped over such that the cutting side 28 is face side up and the scoring side 30 is face side down. Again, the point 108 of the pin 24 is inserted through the aperture 44 on the double-sided mat 12, through the hole formed in the top cardstock 182 (when forming a box top scoreline 198), and through the upper aperture 72 of the curved ruler 16. The cap 26 again covers the point 108 to prevent injury. The cutting tool 20 is inserted in the same eight-inch curved channel 66 to create a box top cut 200 approximately one-inch in diameter larger than the box top scoreline 198. Thereafter, the flaps 192 shown in FIG. 69 are created in the same manner as the flaps 192 illustrated in FIGS. 63-65 for the round box bottom 184. A box top strip 202 as shown in FIG. 70 is adhered to the flaps 192 by an adhesive applied around the interior of the box top strip 202. An overlap 204 shown in FIGS. 66 and 70 enables the box bottom strip 196 and the box top strip 202 to securely adhere to themselves for purposes of stability. Thus, there are no gaps around the circumference of either the round box bottom 184 or the round box top 186. FIG. 71 illustrates pre-engagement of the round box top 186 with the round box bottom 184. FIG. 72 illustrates engagement of the larger diameter round box top 186 with the smaller diameter round box bottom 184 to form the round box 178.

FIGS. 73 and 74 illustrate alternative uses for the curved ruler 16. A curved deckled edge 206 and a straight deckled edge 208 formed as part of the curved ruler 16 are capable of tearing cardstock in the manner shown in FIGS. 73 and 74, respectively. The torn edges mimic deckled edges most commonly included in paper-based or vellum-based stationary, invitations and other hand-made papers.

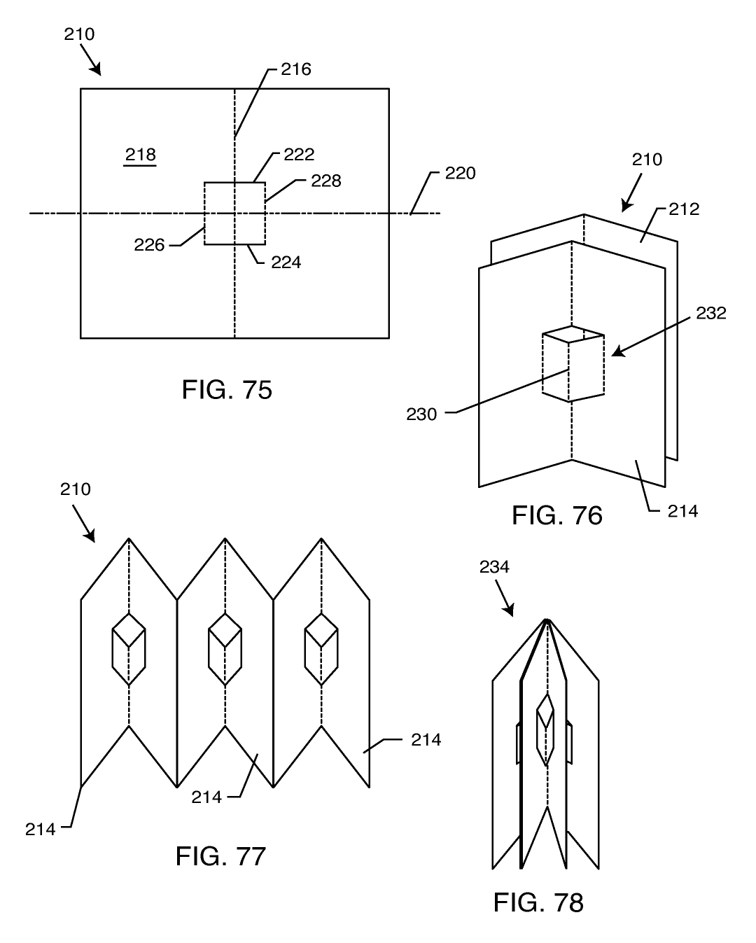

The paper crafting kit 10 of the present invention can also be used to create pop-up cards such as those shown in FIGS. 75-78. A pop-up card 210 is created by selecting two identical sheets of cardstock in the size of the desired card. As shown in FIG. 76, the pop-up card 210 comprises a card cover 212 and a pop-up insert 214. The pop-up insert 214 is glued to the inside of the card cover 212 by any method known in the art. The general pop-up card 210 shown in FIG. 75 is created by scoring a center scoreline 216 through the middle of a blank cardstock 218. The cardstock 218 is then folded about the center scoreline 216. Thereafter, two parallel slits set off from a centerline 220 (FIG. 75) are formed using the cutting tool 20, on the cutting side 28 of the double-sided mat 12. After opening the cardstock 218, a pair of connecting scorelines 226, 228 are formed with the scoring tool 18 on the scoring side 30 of the double-sided mat 12 between the slits 222, 224. A reverse fold 230 creates a mount 232 as generally shown in FIG. 76. In an alternative embodiment, multiple pop-up inserts 214 may be adhered to one another to form a pop-up book 234 generally shown in FIG. 78. Accordingly, the card cover 212 is adhered to the exterior of the pop-up insert 214 on each end of the pop-up book 234.

Although several embodiments have been described in detail for purposes of illustration, various modifications may be made to each without departing from the scope and spirit of the invention. Accordingly, the invention is not to be limited, except as by the appended claims.

1. A process for crafting paper, comprising the steps of:
providing a double-sided mat having a cutting surface on one side and a scoring surface on an opposite side, each surface including measurement indicia;
placing paper on the cutting surface of the mat;
disposing a ruler over the paper;
positioning a cutting blade within a channel formed in the ruler; and
cutting the paper with the cutting blade.

2. The process for crafting paper of claim 1, wherein the cutting step includes the step of cutting an arch, a circle or a straight line.

3. The process for crafting paper of claim 2, including the step of folding the paper between a set of arches to form a three-dimensional structure.

4. The process for crafting paper of claim 1, including the step of aligning the paper with the measurement indicia.

5. The process for crafting paper of claim 1, further including the steps of:
setting the paper on the scoring surface of the mat;
putting the ruler over the paper;
locating a scoring knob within the channel in the ruler; and
scoring the paper with the scoring knob.

6. The process for crafting paper of claim 5, wherein the scoring step includes the step of scoring an arch, a circle or a straight line.

7. The process for crafting paper of claim 6, including the step of folding the paper about a scoreline.

8. The process for crafting paper of claim 5, wherein the measurement indicia on the scoring surface comprises a first line for scoring a box bottom base and a second line offset from the first line for scoring a box top base relatively greater in width and height than the box bottom base.

9. The process for crafting paper of claim 5, including the steps of notching a flap from a sidewall using a cornering device having a pair of angled cutting channels and adhering each flap to the respective sidewall.

10. The process for crafting paper of claim 5, including the step of changing the cutting blade with the scoring knob within a universal tool.

11. The process for crafting paper of claim 10, including the step of storing the cutting blade or the scoring knob in a compartment in the tool.

12. The process for crafting paper of claim 1, including the step of tearing the paper along a deckled edge of the ruler.

13. The process for crafting paper of claim 1, including the steps of catching a lip of a straight ruler on an edge of the mat and sliding the straight ruler along the edge.

14. A process for crafting paper, comprising the steps of:
providing a double-sided mat having a cutting surface on one side and a scoring surface on an opposite side, each surface including measurement indicia;
placing paper on the scoring surface of the mat;
disposing a ruler over the paper;
positioning a scoring knob within a channel formed in the ruler; and scoring the paper with the scoring knob.

15. The process for crafting paper of claim 14, wherein the scoring step includes the step of scoring an arch, a circle or a straight line.

16. The process for crafting paper of claim 14, including the step of embossing the paper with the scoring knob.

17. The process for crafting paper of claim 14, including the step of folding the paper about a scoreline to form a three-dimensional structure.

18. The process for crafting paper of claim 14, including the step of aligning the paper with the measurement indicia.

19. The process for crafting paper of claim 14, including the steps of:
inserting a pin through an aperture in a center of the mat;
poking a hole in the paper with the pin when placing the paper on the scoring surface;
positioning the pin through an aperture in a curved ruler when disposing the ruler over the paper; and
rotating the curved ruler about the pin for scoring an arch or a circle.

20. The process for crafting paper of claim 14, including the steps of:
setting the paper on the cutting surface of the mat;
putting the ruler over the paper;
locating a cutting blade in the channel of the ruler; and
cutting the paper with the cutting blade.

21. The process for crafting paper of claim 20, wherein the cutting step includes the step of cutting an arch, a circle or a straight line.

22. The process for crafting paper of claim 20, including the steps of notching a flap into the paper and adhering the flap to a sidewall.

23. The process for crafting paper of claim 20, including the steps of:
inserting a pin through an aperture in a center of the mat;
poking a hole in the paper with the pin when setting the paper on the cutting surface;
positioning the pin through an aperture in a curved ruler when putting the ruler over the paper; and
rotating the curved ruler about the pin for cutting an arch or a circle.

24. A paper crafting kit, comprising:
a double-sided mat having a cutting surface on one side and a scoring surface on an opposite side;
measurement indicia on each surface of the mat, including a first line on the scoring surface for scoring a box bottom base and a second line offset from the first line for scoring a box top base relatively larger in height and width than the box bottom base;
a ruler engageable with the mat, wherein the ruler includes a channel that aligns with the measurement indicia; and
a cutting blade and a scoring knob selectively insertable into the channel of the ruler.

25. The paper crafting kit of claim 24, wherein the ruler is a curved ruler having a first alignment aperture for scoring a round box top and a second alignment aperture offset from the first alignment aperture for scoring a round box bottom relatively larger in diameter than the round box top.

26. The paper crafting kit of claim 24, wherein the measurement indicia comprises a horizontal line, a vertical line, a circle, or a diagonal line.

27. The process for crafting paper of claim 24, wherein the second line is offset from the first line by one-eighth inch.

28. The process for crafting paper of claim 24, wherein the cutting surface comprises plastic and the scoring surface comprises foam.

29. The process for crafting paper of claim 24, wherein the paper comprises vellum, construction paper, cardboard or cardstock.
